(19) United States
(12) Patent Application Publication
(10) Pub. No.: US 2009/0191897 A1
(43) Pub. Date: Jul. 30, 2009

(54) Environment Characterization for Mobile Devices

(75) Inventors: Roderick Michael Johnson, San Diego, CA (US); Ryan Scott Jones, San Diego, CA (US)

Correspondence Address: FISH & RICHARDSON P.C., PO BOX 1022, MINNEAPOLIS, MN, 55440-1022, US

(73) Assignee: CORTXT, INC., San Diego, CA (US)

(21) Appl. No.: 12/359,160

(22) Filed: Jan. 23, 2009

Related U.S. Application Data
(60) Provisional application No. 61/062,336, filed on Jan. 24, 2008.

(51) Int. Cl. H04W 64/00

(52) U.S. Cl. 455/456.3

(57) ABSTRACT

Methods, systems, apparatus, and computer program products are provided to harness massively distributed, but locally available location, application usage, device usage, network and overall Radio Frequency (RF) systems awareness, processing, memory and connectivity from mobile devices in a manner which would broadly characterize the environments these mobile devices operate within given the capabilities of each type of mobile device to contribute information about its local environment.

### RELATED APPLICATION

This application claims the benefit of priority from Provisional Application No. 61/062,336, for “Environment Characterization for Mobile Devices,” filed Jan. 24, 2008, which provisional application is incorporated by reference herein in its entirety.

### TECHNICAL FIELD

This subject matter generally relates to location-aware mobile devices and infrastructures for supporting same.

### BACKGROUND

A large potential market for Mobile Location Based Service (LBS) services is consumer applications which could operate on the Billions of GSM and CDMA mobile handsets and appropriately provisioned Personal Navigation Devices (PNDs) in service. As Mobile LBS applications proliferate amongst mobile consumers, large volumes of location related information is being transported wirelessly. Underpinning these services are technologies which provide the location of mobile customers with varying degrees of accuracy and validity and or certainty and Geographic Information Systems (GIS) which provide users with a reverse geo-coded location and or series of locations, which provide visually meaningful information alone or in conjunction with other types of location tagged information. Much of the value of these services can be attributed to the location tagged information which is of interest and or of use to mobile consumer or business participants in any given location. Location tagged information includes the location of local Points of Interest (POIs), Gas Stations, accommodations, restaurants, and other such information that characterizes the locale.

To employ mapping and other GIS related services, some mobile location technologies require aiding and or assistance or otherwise some type of external support to provide an accurate, timely and power efficient referenceable location, which usually contains at a minimum a latitude, longitude and possibly altitude and velocity. Additionally, some LBS applications have emerged which can provide a meaningful level of service with less location accuracy than can be provided by the more accurate location aware devices currently in service, such as services which may only require a location defined by an area of 500 meters in diameter, rather than a more accurate location, such as one defined by an area of 10 meters in diameter.

Conventional location tagged information exchange and location aiding formats or standards for LBS require considerable bandwidth, which currently limits overall adoption to customers that can afford the higher data costs associated with the provision of such LBS services.

### SUMMARY

Methods, systems, apparatus, and computer program products are provided to: a) specifically harness the massively distributed, but locally available location, application usage, device usage, Network and overall RF Systems awareness, processing, memory and connectivity from possibly all mobile devices in a manner which could broadly characterize the environments these devices operate within given the capabilities of each type of mobile device to contribute information about its local environment; b) both passively and or actively manages the capture of such information, which is typically poorly formatted for efficient transport and or in a manner which allows it to be useful as information for these purposes; c) which can correctly assess the appropriate distribution and densities of this type of information which should be included in a database and or other such information system or systems and can efficiently collect and remit this information from and to other mobile devices which could benefit from such information; d) which can improve multiple aspects of location aiding and generation including: 1. improve wireless location aiding by utilizing the captured information to improve wireless location aiding payloads and formats for traditional location sources such as GNSS (GPS, Galileo, Compass, Glonass, etc.) (Systems and methods for improving wireless location payloads are described in U.S. Provisional Patent Application Ser. No. 60/956,336, “Method and Apparatus for Providing Location Data with Variable Validity and Quality” the contents of which are expressly incorporated herein by reference); 2. improve location determination for location “unaware devices” including assembling and organizing historical location based information which can then expand and improve the art of location determination for mobile devices and or stationary RF devices with little or none of their own location awareness capability, where such location awareness could then create a much larger constituency of mobile devices which could validly benefit from LBS services; 3. improve bandwidth usage including utilizing the captured information to improve a location aware application's wireless payload sizes and frequencies to make these more economic (U.S. Provisional Patent application Ser. No. 60/957,632, “Location Based Services Information and Transport” describes, some methodologies which could optimize and or otherwise improve the performance of the transport and or storage and or delivery of a broad range of location information, the contents of which are expressly incorporated herein by reference); and 4. improve system performance including Utilizing the captured information to impart details about RF System and Subsystem coverage and health.

### BRIEF DESCRIPTION OF THE DRAWINGS

FIG. 1 illustrates capture of Tx and GNSS location to create location tagged RF Rx.

FIG. 2 illustrates effective signal ranges.

FIG. 3 illustrates triangulation of unknown RF Tx location from located RF Rx.

FIG. 4 illustrates using multiple Rx samples to locate RF devices.

FIG. 5 illustrates an example client location aiding overview.

FIG. 6a illustrates an example GAIM GNSS aiding overview—mobile originated.

FIG. 6b illustrates an example GAIM GNSS aiding server response.

FIG. 7a illustrates an example GAIM FM aiding—mobile originated.

FIG. 7b illustrates an example GAIM FM aiding server response—network initiated.

FIG. 8a illustrates an example GAIM cellular network aiding—mobile originated.

FIG. 8b illustrates an example GAIM cellular network aiding server response—network initiated.

FIG. 9a illustrates an example GAIM 802.11 aiding—mobile originated.

FIG. 9b illustrates an example GAIM 802.11 aiding server response—network initiated.

FIG. 10 illustrates an example distribution of mobile devices and cell towers.

FIG. 11 illustrates an example distribution of mobile devices and cell towers.

FIG. 12 illustrates a drive by example.

FIG. 13 illustrates an example RF Rx threshold analysis of cell coverage.

FIG. 14 is a flow diagram of an example process for updating location data to improve error in the data.

FIG. 15 is a flow diagram of an example process for determining a quality of location data.

FIG. 16 is a flow diagram of an example process for determining a characteristic of a network or device while the device is being charged.

### DETAILED DESCRIPTION

### Harnessing Location Aware Distributive Processing

A geo assisted information management (GAIM) system, methods apparatus and computer program products are proposed that harnesses massively distributed, but locally available location, application usage, device usage, Network and overall RF Systems awareness, processing, memory and connectivity from any number of mobile devices, whether they would be considered to be location aware or not, in a manner which broadly characterizes the environments these devices operate within given the capabilities of each type of mobile device to contribute information about its local environment.

### Active and Passive Methods

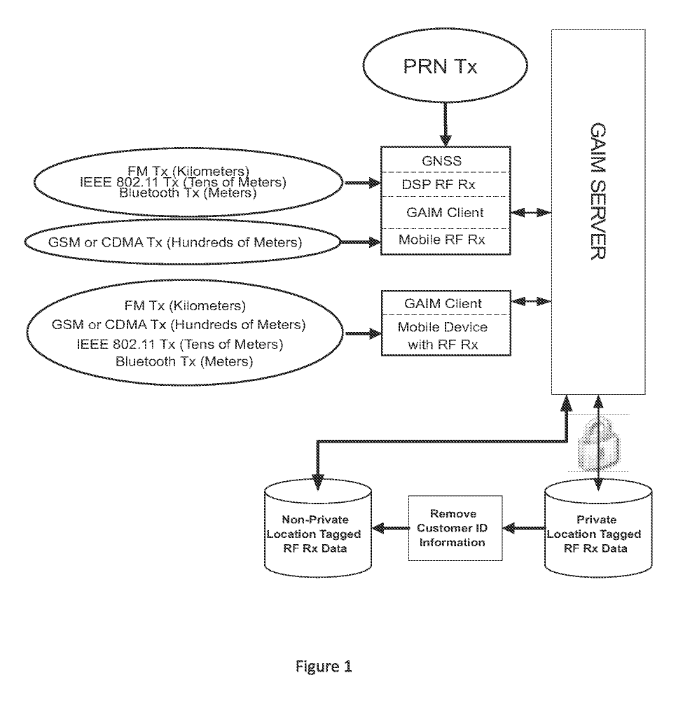

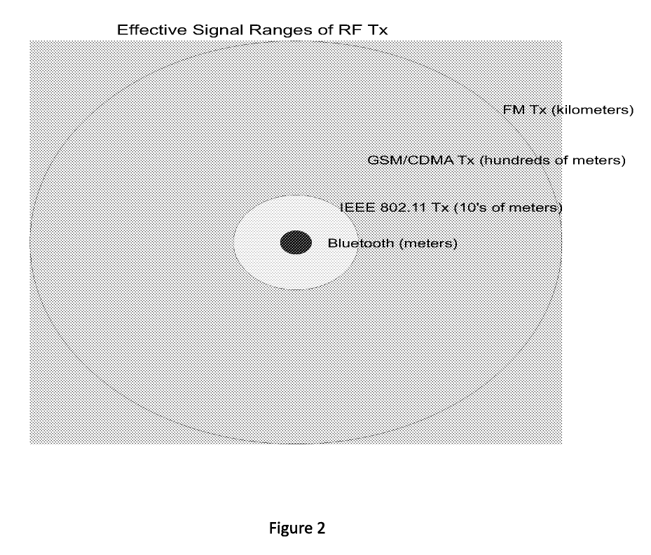

There are two fundamental ways in which RF System and or GNSS type location and or RF signal information could be available from mobile devices; passively and actively. Passive information could be represented by any information which could become available through the normal operation of a device, which could be reused by one or more embodiments of the invention. Such normal operation typically includes some level of activity of a DSP or other such RF component used to characterize an RF signal or signals from within the RF energy present in the environment at the time of such characterization. Active information could be any information which could become available through the activation, outside of normal operating scenarios, of a system and or subsystem of a device, which through such activation could cause information to become available. Examples of passive information gathering or capture could be, but are not limited to, accessing and reusing GSM or CDMA Network management information such as the serving MSC, SMSC, BSIC (serving cell tower) ID's and signal strength, signal to noise ratios, as well as the BSIC NCELL's (Neighboring Cell Sites) and such RF signal and or contained signal information of GSM and or CDMA and or other such Networks, and or associated bit error rates, and or other available information such as FM or Satellite broadcasts and or such similarly available information which could be routinely available through the normal operation of such RF systems. When such information is available concurrent to and then concatenated with GNSS and or other such location information, such resulting information could be referred to as location tagged RF information, and or RF tagged location information, and or could be described as RF aware location information and or location aware RF information, or some combination of such information which could become available during the operation of some combination of RF Systems, GNSS or other such systems and or subsystems, which hereinafter could be referred to severally and or collectively as information. The passive availability of such information comes at little or no opportunity cost to power usage of a mobile device during its normal operation, as the mobile device must have much of this information updated on a fairly continuous basis to maintain its Network and or RF System connectivity for its primary operational purposes, even if such a device is possibly imbedded as an RF System and or RF subsystem to a PND. Examples of active information gathering could be, but are not limited to, activating and then harvesting available information from other RF Systems and or subsystems, which may not necessarily be required during the normal operation of a mobile device or PND performing its primary operational tasks, such as but not limited to any RF System which could form part of any device. FIG. 1 shows one high level example of this architecture.

One example of information that could be included in a Location tagged RF Rx payload:

[Mobile ID, Time, Latitude, Longitude, Altitude, Velocity, Direction, GSM Rx, FM Rx, IEEE 802.11 Rx, Bluetooth Rx].

GSM Rx could be a snapshot or a group of measurements consisting of but not limited to Country Code, Network Code, Regional Code, Location Area Code, Received Signal Strength, Received Signal Quality, Time Advanced, etc.

IEEE 802.11 RX could be a snapshot or a group of measurements consisting of but not limited to SSID, Signal Strength and Signal Quality.

One example of information that could be included in a Location tagged RF Rx payload, where user privacy laws and or guidelines required reduced information to maintain user privacy:

[Time, Latitude, Longitude, Altitude, Velocity, Direction, GSM Rx, FM Rx, IEEE 802.11 Rx, Bluetooth Rx].

In one implementation, systems, methods and computer program products are provided to maintain separate databases for private versus non private information, such as to obviate conditions where use of such private information for non private purposes could be construed to have compromised the privacy of the contributor of such information. Such obviation could be accomplished by stripping or scrubbing any information relating to a user which those knowledgeable in the art could use to relate the location portion of the information to a user.

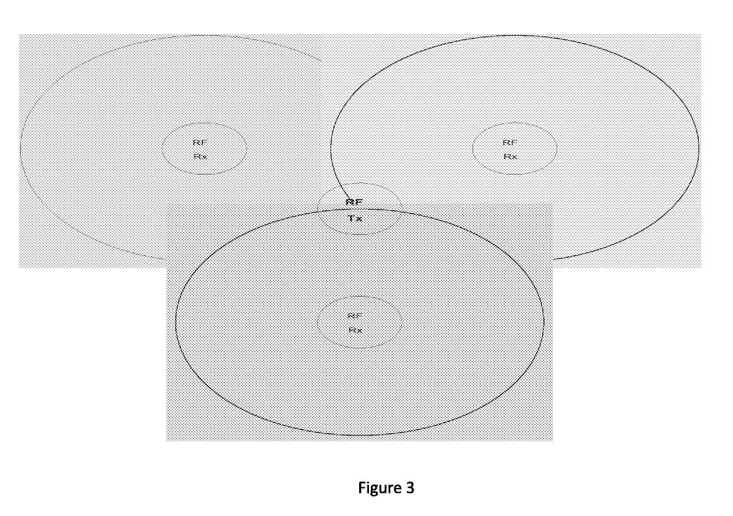

Also, as suggested in FIG. 1, the known peak Tx signal strengths allowed and attendant propagation characteristics of differing frequencies fundamentally describe a maximum range of possible distance that any particular type of RF Rx sample could be in relationship to a Tx source, to have been captured from any particular type of local Tx source, and such knowledge of these maximum ranges, in of itself provides location information about such RF Tx and Rx samples. FIG. 2 illustrates effective signal ranges of RF Tx.

### Strategies to Improve Opportunity Cost of Information Capture

Active information gathering could have an opportunity cost to a device in the forms of additional power consumption due to the operation of the individual RF Systems and or subsystems or local memory usage. The use of additional power due to active information gathering could reduce the overall length of time which a device could perform its primary operational functions on a battery operated or otherwise power limited device. The use of local memory to store actively gathered information may prevent the use of such memory for consumer applications used during normal operating procedures. However as described earlier, these opportunity costs continue to decrease due mostly to the increasing efficiency of these systems, and as such this power consumption and memory usage could be weighed against the economic and or performance benefits to be gained through the implementation of a more active information gathering strategy. In a device such as a PND, as opposed to a mobile device, such as a Mobile Handset, which typically is more dedicated to voice and data operations, one implementation of an active strategy could be to have an RF System, DSP and or other such subsystems enabled on some duty cycle which allowed the capture of information which could be available via the operation of these systems only when they are active or possibly a scheduling algorithm which actively considered power consumption within the constraints of available battery charge. Under both types of gathering or harvesting of information, corollary algorithms sensitive to the devices' available battery capacity, and or sensitivity to peak power availability limitations, and or time (to determine the most reasonable or effective scheduling of active RF scanning, possibly to limit the peak power draw such RF Systems could create if multiple subsystems engage simultaneously) could be used to manage such activities in a manner that delivered the best overall balance between power managed device availability and information availability suited for the device, and or the user and or the application or applications which could benefit from the information made available through such activity. Some implementations could include a combination of passive and active information capture or harvesting, where a location aware device such as a Mobile Handset or PND could use one or more exemplary algorithms to gather RF System information both passively and actively within certain locales until such time as an information management algorithm and or some separate but associative algorithm determined that a locale was well characterized, after which it could effectively maintain time relative information levels through interpretation of the accumulated information which could be passively and or actively acquired, and or subsequently capture passively gathered information within an already characterized locale to continuously improve and or otherwise maintain the value of information over time, and or where power and memory availability allowed, maintain some level of active information harvesting on a continuous basis to maintain a near real time understanding of the environment, or some combination of active and passive information gathering which could deliver acceptable levels of information distribution and density for the purposes intended. These information density guidelines could also include but would not be limited to, the influence of weather and how variations in weather might require higher densities of information. Examples of weather attributes which could require higher information densities could include, but are not limited to, varying relative humidity levels, rain, snow, or other such weather manifestations that could inherently modify the propagation of an RF signal. Information distribution and density guidelines could also include business rules such as economic and or privacy considerations and or other such commercial guidelines, and or other economic influences which could require information densities to be adjusted as a response to such considerations.

Since mobile device power usage, and or a users requirements or preferences, or other application requirements could take precedence over the capture of such information, some implementations allow for such information to be captured with little or no impact on battery capacity or user requirements. In some implementations, the information is captured only when a mobile device is being charged, and or when being charged during an off peak period. Examples of additional benefits of this strategy could be that the captured and locally stored information could be sent during the off peak period (potentially low data costs and or opportunity costs) of a Network with the likelihood that a large percentage of mobile device subscribers would be located at their primary residences, and as such, the information captured would be well distributed across a broad selection of locations throughout a Network's region, possibly improving the resulting validity of the information for characterizing a Network region due to such intrinsic distribution.

### Statistical Significance of Information

Those knowledgeable in the art of interpreting statistically significant volumes of data may also agree that some implementations that operate on a massive scale over potentially as much as a billion or more devices, through which substantial volumes of information became available, would greatly improve opportunities for the expert interpretation, interpolation and analysis of information to actively provide environmental characterization information that could include, but is not limited to, the expert characterization of Network coverage, Network health and operation, the probability of a mobile device's location at any given time, an understanding of the number and type of connectivity options which could be available to a mobile device with a multiplicity of connectivity systems and subsystems, the likelihood that such systems or subsystems will operate in a satisfactory manner within defined areas or regions, amongst other types of new operating efficiencies which could be created for the use of any number and type of mobile and commercial participants that could have reasonable access to such information or analysis though the incorporation of one or more of the preferred embodiments of the invention. Additionally, such information could provide an improvement of performance for stationary and or mobile RF Systems with little or no location awareness, and or possibly offer some level of location awareness to such devices that would otherwise be unavailable without the environmental characterization made available through the implementation and enablement of one or more embodiments of the invention.

Another exemplary use of some implementations would be how the harvested statistically significant information collected and stored, could be used commercially by other third party participants to perform, provide and or otherwise improve the functionality or capabilities of a variety of commercially viable consumer and or business services which could benefit economically from insights and understanding which could be available using data mining and or other such information or data retrieval techniques that those knowledgeable in the art might perform to acquire valuable information or insights into the activities, proclivities, habits, haunts, expectations and or desires of the users, owners, or subscribers of mobile devices or PND's or other such devices or applications which could operate on or form part of the useful operation of such products by a user or users. Examples of such useful commercial data mining or harvesting activities could be, but are not limited to, location aware and or location based advertising of products and or services, the improvement of GNSS type aiding and or assistance services to any number of, and or supporting types of devices which could benefit from such aiding or assistance, the provision of more precise or specific traffic, weather or POI or other such information, E911 type emergency services support, medical and or paramedical services support or other such activities as could be conducted by governmental emergency and or law enforcement organizations during normal and or extraordinary circumstances where information and or analysis of this type which could be extracted through expert or other means could be in the national interest, or other commercial activities where enhanced economics or operational performance or other such similar enhancements to the operation of such activities could be created.

In most circumstances where more accurate location information is required for LBS applications, GNSS type imbedded devices are used. Even though great efforts have been made by device manufacturers and vendors to incorporate GNSS, IEEE 802.11, FM, RFID and other types of RF Systems into mobile devices such as handsets and PNDs, little effort has been made to utilize the characterized operating information of available RF Systems or subsystems to improve the performance of the other RF Systems or subsystems which could be present on such devices. Some implementations do so to improve the performance of Mobile LBS services, mobile and or RF applications in general, as well as incorporated GNSS devices. Examples where these types of co-located RF systems could symbiotically provide informational support of this type could be, but are not limited to, where a drop in signal strength (such as when a vehicle drives into an underground parking garage) being received by a GSM receiver could be used to provide interpretive information for the purposes of determining when and if a GNSS receiver should turn on to attempt to deduce a location, or conversely using an active GNSS and or utilizing a recent location generated by a GNSS to determine when a known RF connection might be available for use, or possibly where near real time operating feedback from a GNSS device might cause a mobile device to actively search for more easily available location information from a variety of other sources, possibly even from other co-located mobile devices with GNSS or similar location capabilities that are able to provide valid location information.

When information of any various types is captured concurrently to the acquisition of a location of a known validity and quality, and this information is assembled into a data payload and or is recorded into memory, or otherwise made available to other applications or systems, it can be considered to be location tagged. One example of how current and or historical location tagged RF signal information could improve the performance of GNSS aiding and or other commercial uses could be where a mobile device concurrently recorded RF System Signal information for the purposes of providing a general understanding of where unique RF sources such as, but limited to, GSM and or CDMA Cell Towers, IEEE 802.11 and or Bluetooth hotspots, were located within the operational vicinity and or environment of an operating mobile. Such characterization being accomplished by triangulating and or trilaterating location tagged RF signal information captured from spatially distributed, and known locations, and or possibly as yet unknown locations within a region by other mobile devices over some time duration. Such location tagged RF signal information, which could include the ID of such RF sources, could be retained and used by an individual mobile device or application, and or some grouping of two or more mobile devices sharing such information on a peer to peer basis, or could be two or more mobile devices collectively remitting such information to a server database or other such type database system which could organize the collected information in a manner which would improve its usefulness for determining where RF signal sources are located, such as Network Cell towers or other such RF signal sources, which could broaden the known characterization of an RF locale and or region and or an RF environment and therefore the likely locations of such RF signal information sources. The usefulness of this information for such purposes could be fairly proportional to the density of information captured for such purposes, where the definition of an as yet unknown location of an RF Signal Source could only become known through the provision and interpretation, interpolation and or otherwise the analysis of some minimum amount of known information, where the validity and certainty of this information could be continuously improved as further, known to be valid, information could be included in such calculations. In some circumstances, and possibly increasingly in the future, a number of RF Signal sources could include in their transmissions, location information of a determinable validity and quality, which could also become useful information for use by the proposed system. However, the vast array and volume and types of such sources today do not include such information, and as such some implementations can operate with or without such information, as the known locations of the RF Systems receiving said signals, in sufficient density and distribution within a locale, provides sufficient information for the purposes of enabling many system benefits.

### Using Information Distribution and Density Rules and or Guidelines to Improve Resource Utilization

In conventional systems known locations and IDs of towers are used to characterize the location of a mobile device (one example could be where a mobile device in a known location captures RF signal information with a known characterization, which suggests that a mobile device is within a certain distance of an RF source, such as a Cell Tower). With the systems proposed the same mobile device and or separate mobile devices could capture similar information some appreciable number of times in numerous known locations surrounding the Cell Tower. At a minimum, three of these valid information sources which are appropriately distributed spatially around the aforementioned Cell Tower could be used to triangulate and or otherwise extrapolate a rough location defined within a region where the Cell Tower must be by using RF propagation rules used by those knowledgeable in such art, such as illustrated in FIG. 3.

Further location accuracy of the Cell Tower could subsequently be extrapolated by including any number of additional valid information sources from any variety of validly distributed locations surrounding the Cell Tower to further improve the accuracy of these calculations. However, there would come a point where additional information source availability would likely not appreciably improve the accuracy of such a calculation. It could be said at that point that the amount of distributed information available with which the Cell Tower's location could be calculated had become sufficiently dense for the purposes intended, after which further information collected would be essentially redundant for the purposes of improving such a calculation.

Some implementations include the use of an algorithm, by a client application such as but not limited to the CorTxT GAIM client application, which could expertly determine when information distribution and densities sufficient for the purposes of any number of uses of such information had been reached. Other possible considerations of such an algorithm could be to make such decisions based on the available memory and or processing capacity of an individual mobile device, and or making decisions based on the time validity of such information as could be retained in memory of the mobile device and or where a server based version of the algorithm recognized an inadequacy in information distribution and density within the locale a mobile device was operating in, causing the server algorithm to direct the client algorithm to capture information expressly for the purposes of improving the quality, and or validity and or time relativity and or overall distribution and or density of information within a locale, which could be needed for the purposes of one or more algorithms to meet the information requirements of a system, such as but not limited to the GAIM Framework, could require within the locale to meet its intended purposes.

It could be possible, when considering that such a strategy could be used across a broadly distributed large constituency of mobile devices operating within a Network territory that the location of every Cell Tower operating within the territory could be likewise determined with considerable accuracy once the information distribution and density requirements of an information service, such as but not limited to the GAIM information Service, had been satisfied.

### Location Aiding

A system is proposed which utilizes harnessed distributed information to make decisions about what methods are available to determine a user's location and then implements the most wirelessly payload efficient manner to meet or exceed the user's requirements. Location aiding embodies deciding the best manner to meet an application's request for location through alignment of a mobile device's and or a remote system's location capabilities with the end application's requirements.

Using Samples from Non-Location Aware RF Sources as a Source of Location Information

In some implementations a mobile device and or any number of mobile devices with a GNSS and or other such type location device and one or more RF Systems, such as an FM Receiver (FM Rx), where an Application such as the GAIM client application, but not limited to such application would location tag FM signal information, hereinafter called FM Tx, as FM Tx became available through the normal operation of the FM Rx or manage an actively controlled FM Rx sessions to scan the full breadth of FM Tx frequencies at known locations. The following example could also apply to any RF System which could contribute RF Information with sufficient distribution and density to be useful for the purposes described.

Many mobile devices use RF subsystems capable of monitoring a broad number of frequencies and modulation techniques, such as Bluetooth and IEEE 802.11 and are also FM enabled, which allow a mobile device user to use their mobile to listen to FM stations, as an example. Those knowledgeable in RF engineering art would generally agree that in North America as one example, but not limited to this example, a great deal of signal energy inhabits the 88 MHz to 108 MHz frequency band, hereinafter referred to as the NA FM Band. DSPs would be particularly useful for sampling this frequency band and then determining whether signal to noise ratios will allow any particular signal to be useful for making an FM station selection which a user could listen to. Most of this signal energy emanates from private and or commercial FM radio stations.

As opposed to the previous example, which described the possible distribution of Cell Towers within a Network, which operate within a well characterized set of frequencies within fairly well known and understood signal levels that are used by mobile Network operators, and typically exhibit a reasonably characterized distribution due to the coverage requirements of a Network, FM Radio transmitters can operate over a wide range of transmission levels using any number of types of equipment strategies, and many of the sub bands within the NA FM Band are reused by different licensees within different specific regions or territories within North America, which collectively could make the characterization of the source of such signals more difficult than the previous Cell Tower example. However, since each FM licensee operates their FM Radio service within specific frequency bands within the NA FM Band, each station will deliver FM Tx within its licensed section of the band within any particular region, and therefore these individual sections of the NA FM Band could be considered and or otherwise used, as a form of unique identification within any particular locale within North America.

These same considerations could be applied to just about anywhere in the world where FM broadcasters operate. Even though the propagation characteristics of the much lower frequency NA FM Band are quite different than those used for mobile telephony, there are still fundamental propagation theories which apply, and could be used by those knowledgeable in the art of the application of such theories. Since the power level which any particular FM station is broadcasting at could still be an unknown, capturing an FM Tx, for example 10 kilometers from the broadcasting source, would have little or no informational value other than that the GNSS enabled mobile location would be known and that the FM Tx captured at that location would also be known. If this same mobile device subsequently captured information from this same FM Tx 100 kilometers from the broadcasting source, and the GNSS enabled mobile device captured the same FM Tx again, and this same process was repeated, for example, at 10 kilometer intervals as the mobile device moved in a straight line towards the same FM Tx, there would likely be a characteristic increase in signal strength perceived by the FM Rx and recorded by the client application during this sequence, or what could be described as the FM Rx signature response for each location that an FM Rx is recorded. If two other similarly capable mobile devices, also 100 kilometers distance from the same FM Tx location, but each starting from a position 120 degrees from the others in respect to the 200 kilometer diameter circle formed (representing an area of 314 square kilometers), similarly recorded the FM Tx every 10 kilometers as each moved in a straight line towards the same FM station, they would likely record some similar characteristic signal responses from the FM Tx.

Using triangulation, and such information gathered, a reasonable characterization of the location of the FM Tx could be determined by those knowledgeable in the art, even though the power level at which the FM Tx broadcasted and the location of the FM Tx were completely unknown, even though the total number of location tagged RF Tx samples involved in this calculation were limited to the 30 suggested. Similarly, if during these same sequences, the client application in fact was directing the FM Rx, which could be a DSP based RF receiver, such as a software radio or cognitive radio or other RF System to scan the entire NA RF Band during the sequence, it could be capturing some form of characteristic signal response during these same sequences from as many FM Tx sources, hereinafter referred to as channels, as may be present in this locale when such sequences occurred, and for example, this number of unique FM Tx channels could be 10 different FM Tx channels emanating from 10 unique but unknown locations.

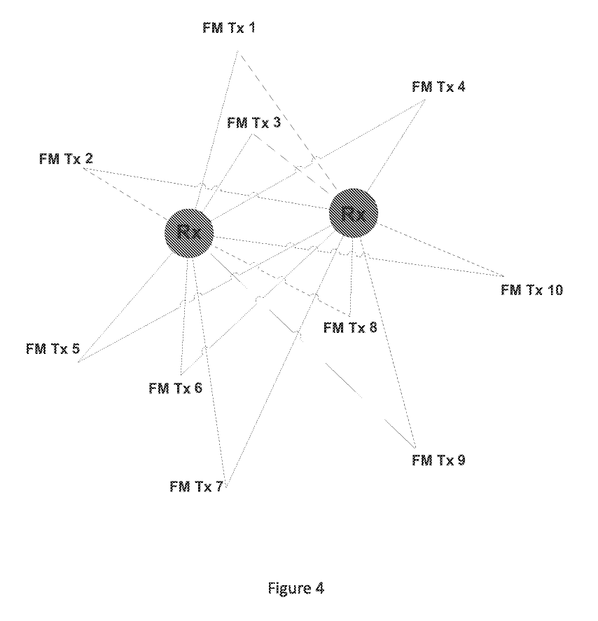

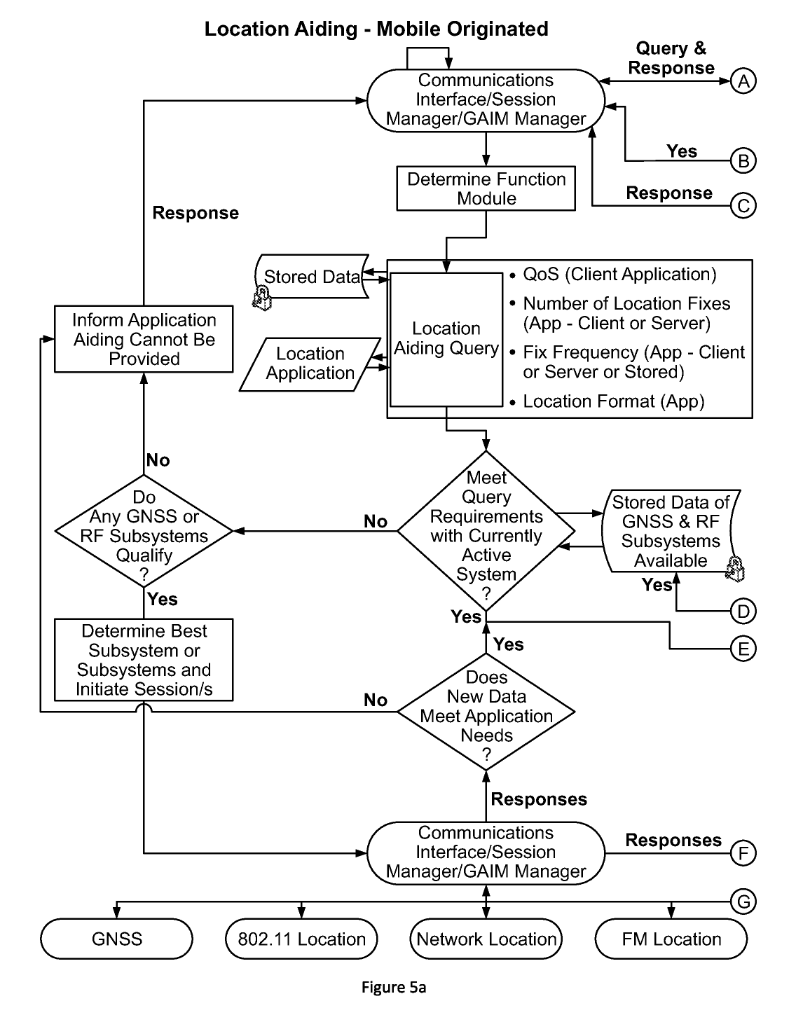

Assuming that the 10 uniquely located RF Tx channels were, as in this example, in 10 unique locations, distributed somewhere within the circumference of the 200 kilometer circular region, each of these could also be effectively triangulated with the 30 samples of unique but concurrently collected RF Tx. Conversely, once the rough location of the 10 Unique FM Tx sources had been established, through such a sampling, any new mobile device which could provide a subsequent FM Rx sample containing signal information from these same 10 channels, from somewhere inside the region, could have its location deduced to some level of validity by comparing such sample to the location tagged samples already collected, as illustrated in FIG. 4.

Under normal operating circumstances, where location tagged FM Rx samples could be available from within a larger subscriber population of a Network's customers in the region, a much larger distribution of samples, possibly blanketing such a region, taken over a much longer period of time, could be captured, which would vastly increase the potential for this information to fully characterize the FM Tx environment described in the example, and could greatly increase the accuracy of locating any untagged FM Rx. Once a large enough and amply distributed sampling of location tagged FM Rx had been captured, which could involve thousands of mobile device participants delivering thousands of such location tagged FM Rx samples, a database containing 314,000 such samples or 1000 FM Rx samples per square kilometer could be formed. Such database formation, using one or more of the exemplary embodiments of the invention, could apply information inclusion rules, location distribution and density rules and guidelines and or FM Rx density rules and guidelines and Time Value rules and guidelines which could apply to which samples should be inserted into such a database, where such information inclusion, rules and or guidelines, could include but are not limited to:
The sections of the NA FM Band to be included
The signal strength of the individual channels of the NA FM Band to be included
The signal to noise ratios of the FM Rx Channels to be included
The bit error rates of any FM Rx to be included if such signals were digital FM signals
The type of FM Rx device which recorded the signal information
The time at which the FM Rx was sampled
The Latitude and Longitude and Altitude location of FM Rx included
The Velocity and Direction of the mobile and associated signal change
The quality and or validity of location information included
The number of samples per square kilometer to include (location density of FM Rx)
The time value, and or the average age of samples to maintain

In this example, even though thousands of mobile devices delivering an average of 1000 FM Rx samples each could result in millions of FM Rx samples, the example rules and guidelines which determine the location distribution and density of FM Rx samples desired could limit the total number of samples to 314,000, after which time value and or average age of the sampling might be used to maintain the quality of information contained. Since random samplings of this type will likely mirror the actual distribution of a mobile population within such a territory, it is very likely that many locales within the 314 square kilometer region would present much higher sample volumes than others, and therefore many locales within the region would supply sufficient samples to meet or exceed the location density rules and or guidelines fairly quickly, whereas other locales where background mobile subscriber densities were much lower could require samples to be remitted for a longer period of time before sufficient samples had been acquired and included to satisfy the distribution and density rules and guidelines within such locales of the region. However, assuming that some appreciable background distribution and density of mobile subscribers were available within every locale of the 314 square kilometer example region, eventually the location distribution and density rules and guidelines could be met for the entire 314 square kilometer region.

Once these guidelines had been met, then the amount of samples required to maintain a database with an understanding of the FM Rx environment within the region would be met, however it could be that the time value and or average age rules and guidelines for FM Rx samples would still require newly acquired samplings to be inserted that would then displace older samples, which Time Value and or age rules and or guidelines considered to be of lower value for the purposes of FM Rx characterization within a given locale of a region due to their age. This could possibly be required to account for changes in the environment, changes in the FM Tx, environmental changes such as new buildings, weather, foliage, background RF noise levels and or other such dynamic changes which can occur in an environment, many of which could influence the characteristic FM Rx signature responses in a locale or locales of a region. It could be further described at this point that the equivalent of an FM Rx mapping database had been created, where sufficient information densities, meeting distribution guidelines existed within the entire region to understand the characteristic FM Rx response within any given locale of the region, which if such database was then aligned within a GIS/Mapping database, could provide a textual and or contextual and or visual representation of the FM Rx environment, where the characteristic FM Rx response within any given latitude, longitude and altitude of the mapped region would be known. Those knowledgeable in the art of understanding the signature response of FM Rx could then compare the signature response of FM Rx from any number of other devices which may not include a location tag to the resulting map, which through such comparison could fairly accurately provide the location of the mobile device providing such an FM Rx, by selecting the location within the region with the FM Rx which best matched the signature response of the FM Rx being compared.

A combination of an FM Rx information database such as described, and a similarly organized database of Cellular RF information, where both sources of information were integrated into a homogenous location tagged RF Rx database using methods proposed could yield superior location accuracy of a mobile device which could deliver an RF Rx sample which characterized both FM Rx and Network Rx information and or possibly any other such RF information, such as 802.11 and or Bluetooth, which could similarly improve the likelihood of determining the location of a mobile device. Such rationale could be consistently applied, where two or more RF System frequencies and or types were similarly available.

### Use of RF Subsystem Characteristics to Improve Location Quality

Some implementations use individual and or multiple frequency RF information captured concurrent to the operation of an imbedded GNSS system, whereby an application which had access to the flow of location data emitted by a GNSS system could filter out location fixes made in error by using expert interpolation of other multi-frequency RF System information, such as, but not limited to peak signal changes, signal to noise changes, and the rates of change of these signals, changes in Doppler, or other such RF operating criteria which might prove useful for the support or operation of a stationary and or mobile GNSS. Examples of such filtering could be, but would not be limited to, where a GNSS inadvertently used a multi-path frequency to calculate a location fix in error due to the difference in distance of the direct versus reflected (multi-path) signal from a satellite and or satellites which caused the GNSS to generate a location in error, for example out by 100 meters in reference to the actual location.

Concurrently, the filtering application could analyze background signal levels and the rate of change of these signal levels, and or the associated Doppler rates and or changes to the Doppler rates of these signals at the time of the location being generated and be able to deduce through comparison of this other RF signal information that a location fix must be anomalous and therefore in error as no similar synchronously anomalous changes had occurred in the RF signal domain being monitored and analyzed at the time when the location fix in error was generated. One example of such RF signal analysis could be where one or more DSPs performed such analysis and then provided appropriately error filtered PRN, RF and or other such data for post processing of such information by or within a GNSS system.

Another example of the use of the information to be gained by this type of error filtering could be to flag and record these types of errors in their general locale to build a database for a multi-path signal prone area or areas where this or other such types of anomalous RF behavior had been recorded, which in turn could be remitted to other local devices and or a central database or separate dedicated database, or other such database services which could use such data from any number and or type of similarly implemented devices, that could be used to provide support to other GNSS systems and or GNSS aiding and or assistance systems or services either in the form of a downloadable database, and or in the form of a GNSS support service which could then improve the error handling of such devices and or could use such information to perform post acquisition analysis of location data presented by a GNSS in an effort to reduce and or eliminate location fixes which were likely calculated in error due to the known anomalous behavior of identical and or similar GNSS devices within a region known to be prone to multi-path or other similar RF signal errors. Another example could be where such post processing and or filtering of GNSS locations was being performed with the additional support of a GIS Mapping system, which could deduce through a combination of location and or velocity information that a mobile GNSS must be operating from a navigable roadway, and that as such could only still be on some type of navigable roadway within the locale of the location data available, which could use the multi frequency information to further characterize which navigable roadway and position on such roadway is a more likely location of the mobile GNSS than the location fix generated in error would presuppose, such as that an individual location infers that the mobile device is not on a roadway, yet would appear to be moving at an appreciable velocity.

Exemplary uses of such managed collection of information could include, but would not be limited to, using the collected RF signal information to more clearly discern where a mobile device was located when requesting GNSS aiding, or was otherwise uncertain of its locale, and or improving the performance and or accuracy of a Network based location awareness system which mainly relied on RF signal information and characterization for the purposes of locating mobile devices, such as when a system of this type was used for E911 or other types of location services which could benefit from locating a mobile device and or its user with a higher degree of accuracy and or when a primary location awareness device such as a GNSS, and or a Network based location service were otherwise unable to provide a location sufficiently accurate for the purposes of such services.

Current Network based location Services typically relying on the RF signal information generated during a location session must settle for a location determination which describes a region of some area around a theoretical location, based on the probability of the collected signals of a mobile device from within a group of Cell Towers emanating from within such a region. Having a database which contained location tagged RF signal information, such as that collected via one or more embodiments of the invention, which could be used comparatively would inherently improve the accuracy of such a system, as the information used for such comparison would not be relying on a theoretical location for the RF signal information, but rather comparing to a known location source for such information, which those knowledgeable in the art could then use to further improve the accuracy of the location determination resulting from this comparative analysis.

It should also be noted that once a statistically significant amount of RF signal information with location tagging had located the sources of such information with sufficient accuracy, that this location tagged RF signal information database could be further utilized to act as a standalone reference location database for any other number and or type of services which rely on an understanding of where a mobile device and or its user are, simply by comparing recently captured RF signal information to the location tagged RF signal information contained in the database of either a mobile device or a database service such as but not limited to the proposed applications, and that if the inferred location of a mobile device and or its user could be discerned by only having current RF signal information available from such a mobile device, was considered to be of sufficient accuracy for the purposes of a third party service, such as, but not limited to, a location based advertising service and or the end customers of such as service, that it could be that this information could then form the economic basis for the provision of such a service without the need for further location awareness systems and or support, thereby potentially reducing the time and or cost and or resource utilization typically involved with the pursuit and or provision of such time sensitive location data in comparison to current strategies employed to effect such services by those knowledgeable in the current art.

Examples of such services could be, but are not limited to, search services, and or ad supported search services, and or POI services, and or Traffic services, and or Weather services, and or Mapping update services, or other such services where a sufficient understanding of the location of a mobile device and or its user or any number of mobile devices and or their users could allow such a service and or services to be rendered through the use or reuse of information made available through one or more preferred embodiments of the invention.

Since the original GPS satellites were deployed by the US Government, a variety of satellite navigation systems have been implemented in anticipation of greatly expanded use of location services. GNSS and their underlying hardware and system solutions could provide an end user the ability to work anywhere anytime, while providing a level of accuracy appropriate for many LBS applications which actively require location information with some level of time validity to provide services to a user. GNSS satellites continuously broadcast a stream of encoded data which ground based GNSS receivers decode and then interpret. Other terrestrial RF sources typically concurrently broadcast a variety of useful sources of information on either a continuous or Ad Hoc basis, which could contribute data which could be useful in characterizing a mobile device's environment and or locale if it could be organized in a manner which could further improve the operation of a location awareness device such as a GNSS.

To generate an accurate location, the GNSS on a mobile device must operate long enough to decode and interpret signal information from a number of PRN RF signals available as reference sources. Collectively, these sources could be used to triangulate, trilaterate or otherwise determine a location of sufficient validity and quality to be of use by LBS and other such types of applications. In any case, the probable validity and or accuracy of a location generated via a GNSS, and or where other information could be available to a GNSS or application, such as a client application using one or more proposed methods, which might manage such information from a GNSS and or other sources of location information to generate a location is likely to be more successful in this effort if the distribution and density of this information is sufficient for such purposes, such as proposed herein.

### Location Aiding Session Management

Inside applications such as, but not limited to, the GAIM Framework client and server applications decision making can play a key role in the overall performance of a service (such as, for example, location aiding where some combination of GNSS, Network, 802.11 and FM based aiding may be required). The provision of higher performance location aiding, and or determining the most appropriate location aiding response to mobile devices or applications which request such location aiding, requires a new level of local decision making logic at the mobile device client application level which is capable of evaluating the location aiding resources which may be available, possibly before such aiding request is sent to an aiding service, and or during a location aiding session. At a client level, the acquisition of information from GNSS, Network, 802.11 and FM subsystems during a client managed location aiding session, in turn could require multiple concurrent subsystem sessions to be managed uniquely to assemble sufficient information to satisfy the overall location aiding session requirements.

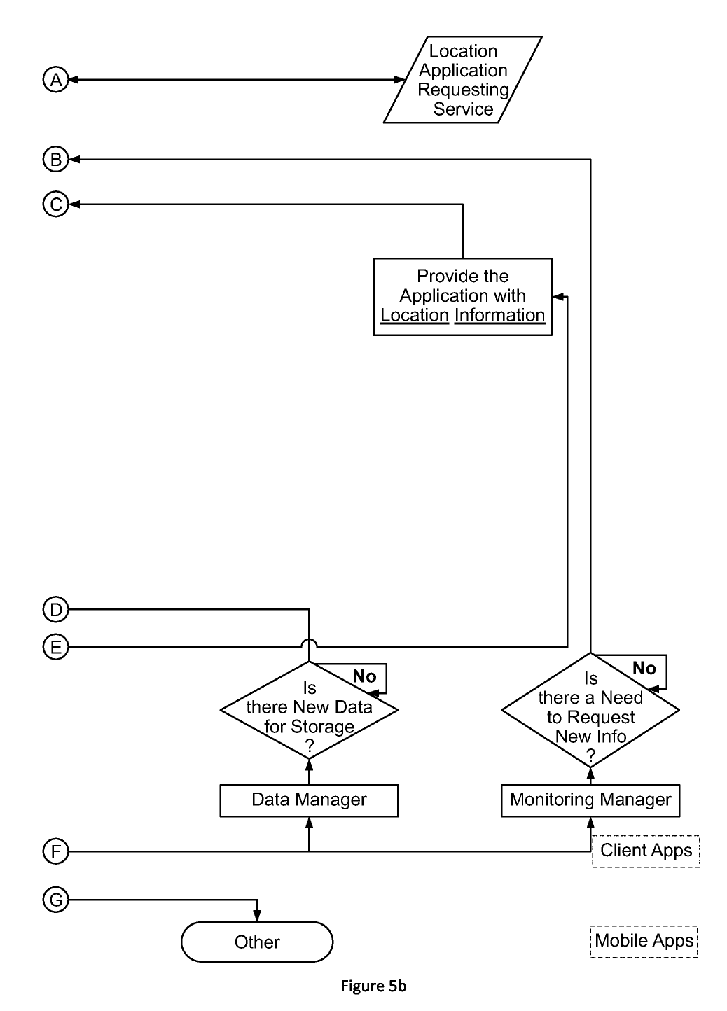

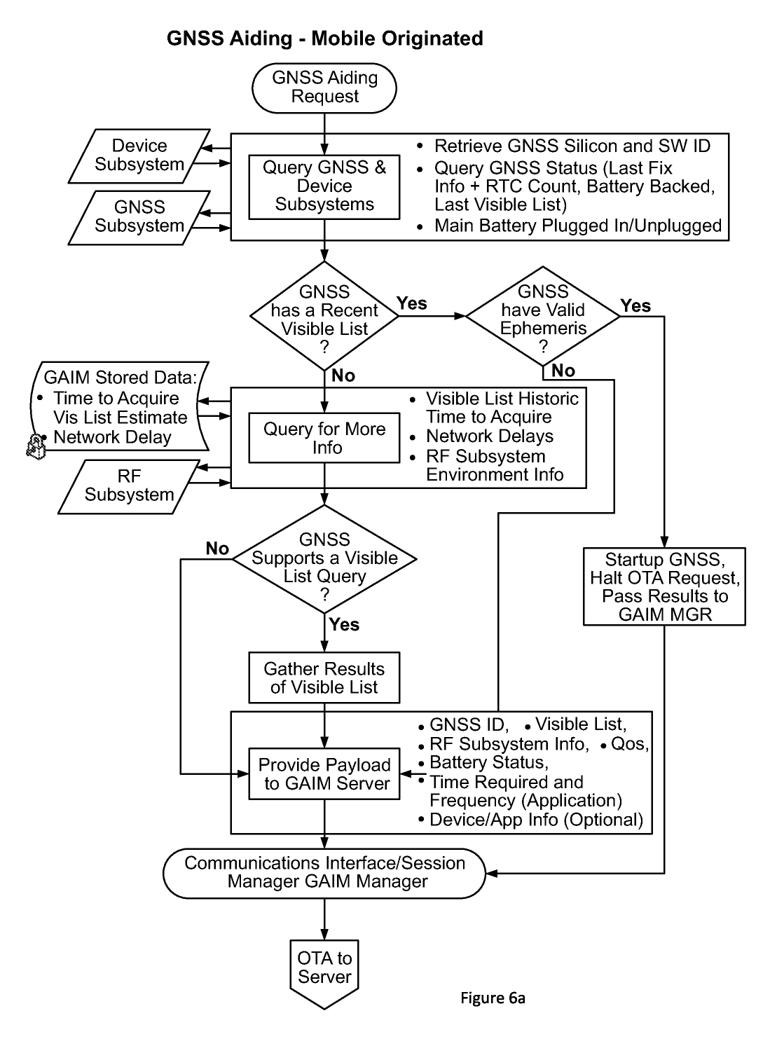

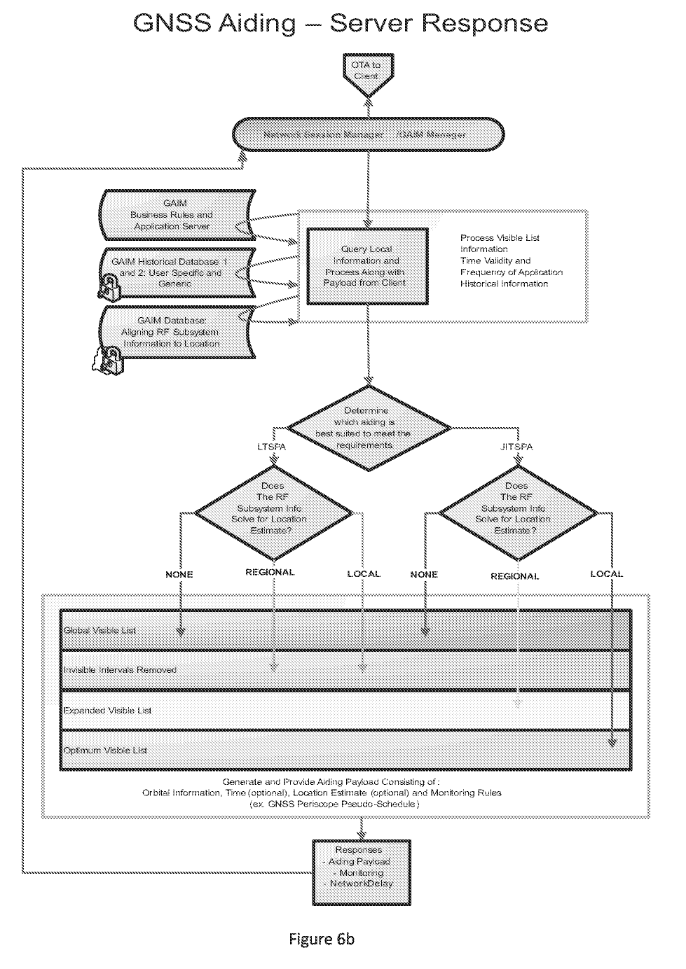

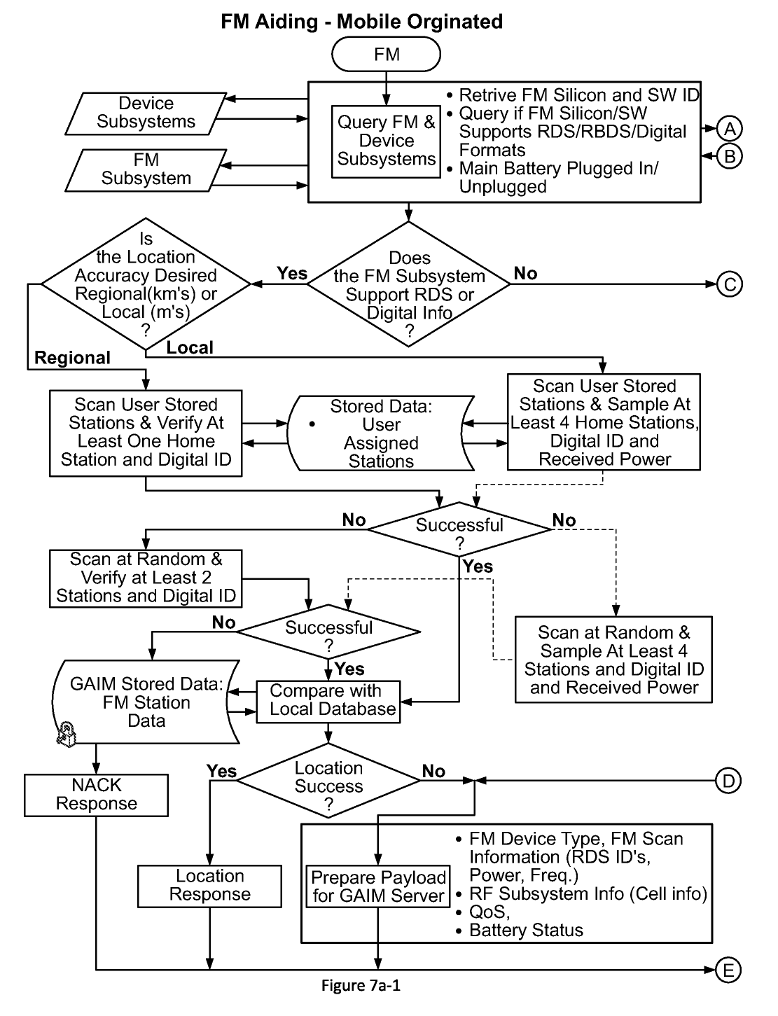

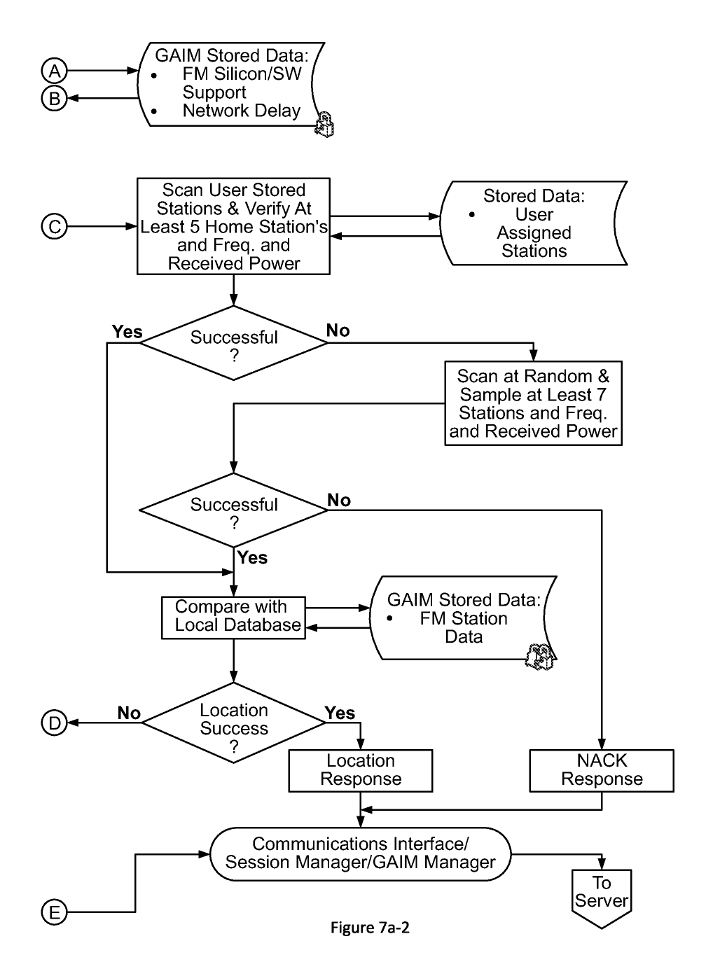

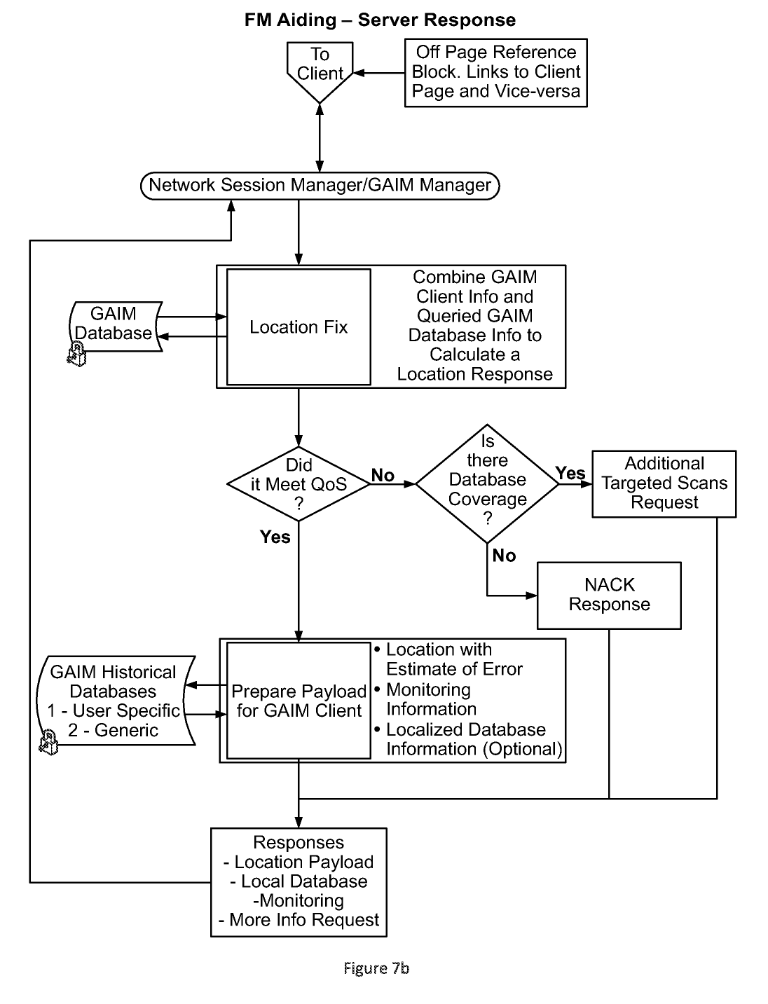

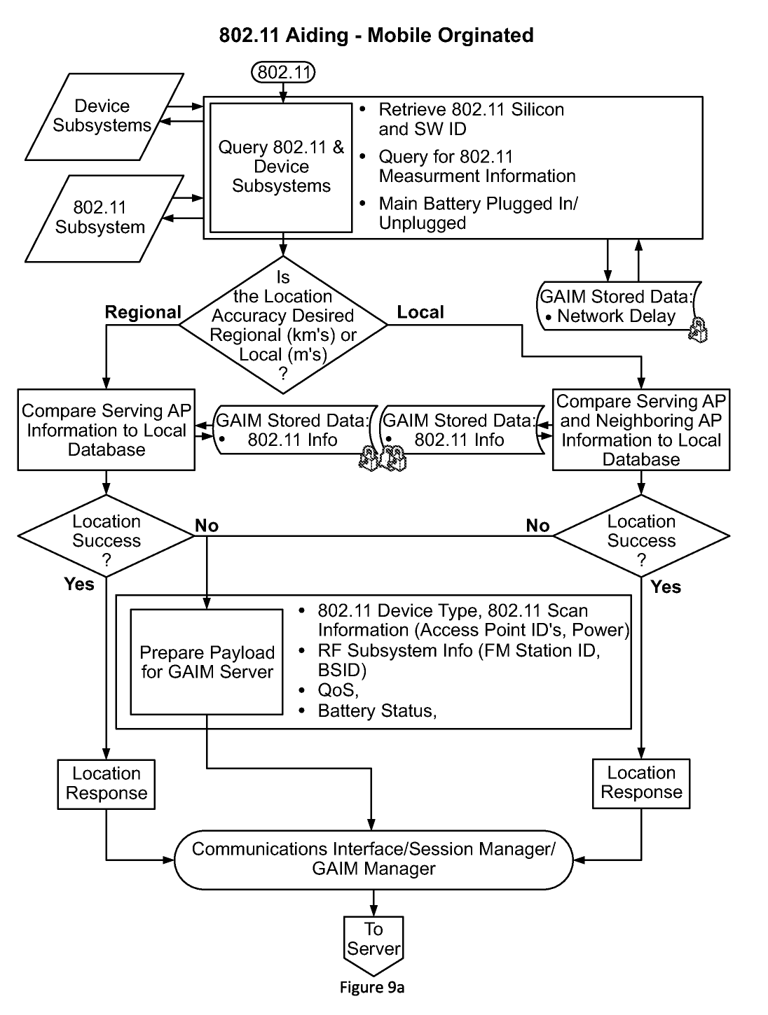

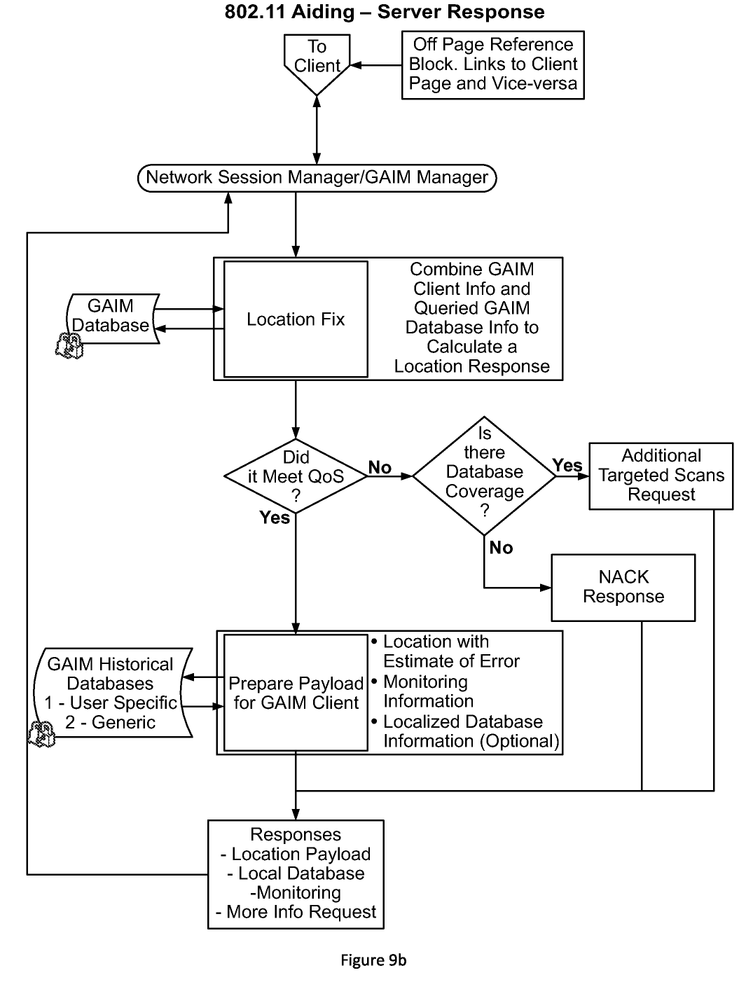

The examples provided describe possible process paths followed to make such decisions when a location aiding request is mobile originated or Network Initiated in nature. While the type and number of decisions which may come into play during a location aiding session could be the same, it can be seen that the process flow could be different when a location aiding request is not mobile originated, such as from an external Network Initiated source making a location aiding request to a server application, such as but not limited to the GAIM Server. Examples of how such logical decisions could be made at a higher client application level supporting a mobile originated request or where a Network Initiated request is managed, but not limited to such examples, could be such as described in FIG. 5 where location aiding decisions are made before engaging the GNSS, Network, 802.11 and FM subsystem level, possibly choosing one or more of the subsystems to be used for specific location aiding as opposed to others which may be available. Since it is highly likely that these subsystems would operate autonomously and asynchronous to each other or could be in operation for other specific tasks, each must be managed within individual location aiding sessions, such as the examples shown in FIGS. 5 through 9b.

In some implementations, the higher level decision making algorithm may be required to first characterize the initial location aiding request of the mobile device (whether via a bundled and resident mobile device application or via Network Initiation), which could be any of a number of separate applications such as, but are not limited to, Turn by Turn navigation, and or location mapping services, and or Buddy Find services, and or Point of Interest (POI) services, and or search or Ad based or supported search services, and or any such service which could be provided where some value added portion of the service requires location aiding and or location information of some type.

The large breadth of services which may need location aiding, such as those described, typically also have a wide range of location aiding needs. To satisfy these needs could require a location of 10 meter accuracy, such as could be generated by a GNSS, or possibly a location which can place the mobile device somewhere within an area defined by a 500 meter or more radius, which could be supplied by a variety of other location aiding solution paths available to the proposed system, many of which could be derived faster and or by utilizing less resources and or transmission bandwidth and or cost less than the alternatives.

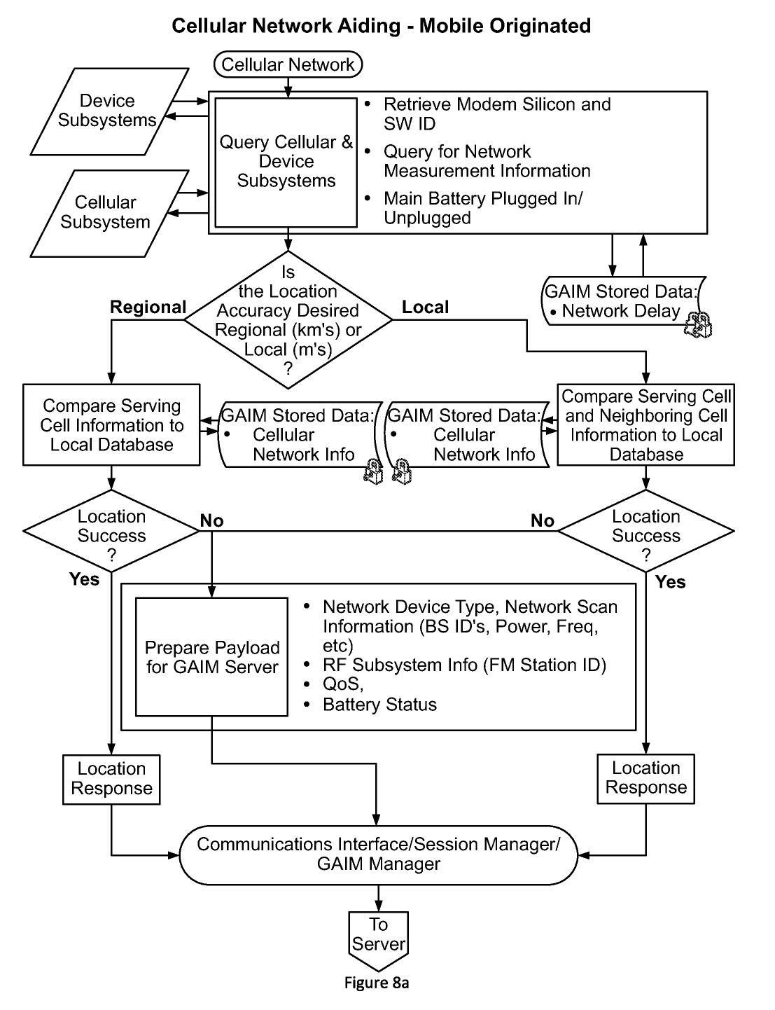

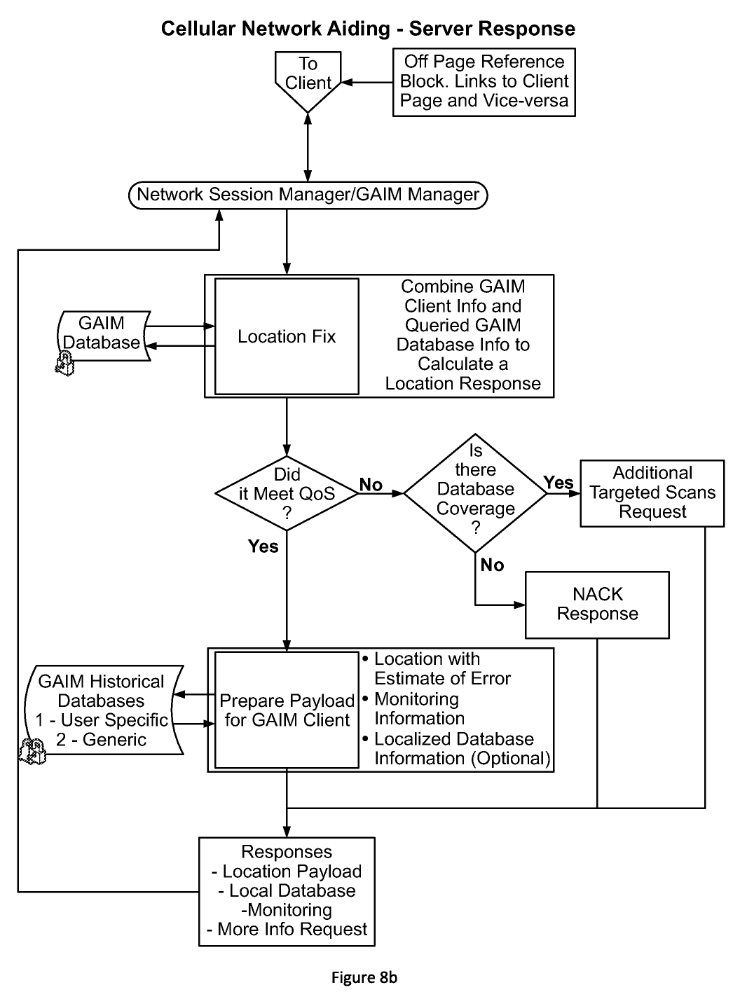

In some implementations where a client application, such as but not limited to the GAIM application, might manage a location aiding session in a manner that weighed location information availability against location accuracy and associated resource overhead could be where one or more location aiding modules were used by the client application to provide the most appropriate location aiding for each unique aiding request. Such modules could include any module required to capture information which could be used to provide location aiding information from any RF Systems contained in a device. These systems could include GNSS, or Cellular/Network RF Systems, or alternative RF Subsystems such as FM, or 802.11 as shown in the example FIGS. 8a through 11.

It can be seen from the examples shown that while all this information could be used, or some combination of the information available through interrogation of these systems could be used by a client application, such as but not limited to the GAIM Client application, in some implementations each module manages the individual system resources as separately managed sessions, each of which could form part of the location aiding solution which the GAIM client application may choose as most appropriate for an individual location aiding request.

It should also be noted that in a circumstance where either a client application or a server application, such as but not limited to the GAIM applications, recognized that insufficient information distribution and densities existed within a locale, that possibly one or more subsystems could be engaged to capture such information, and that each could act autonomously to provide such information for these purposes and could be delivered as part of the location aiding payload and or delivered as a separate payload or payloads, or possibly remitted within the originated location aiding request payload.

### User Expectations and Convenience Versus Urgency

Some implementations of the system can treat user initiated location aiding requests and remotely initiated location aiding requests differently. In some implementations, one of the determining factors for managing a location aiding session could be the level of urgency assigned to a location aiding request, such as timing urgency, where the proposed system could manage a session based on meeting session requirements within an allotted time to meet a user's expectation, as opposed to an automated location aiding session, such as harvesting information to characterize an environment which may have little or no time urgency assigned.

By definition, most requested location aiding scenarios have some level of urgency, if only to meet or exceed a user's expectations and or to ensure that the convenience such services are intended to deliver is provided. Since location services are constructed to mainly provide some level of convenience for the user, such as directions or information about local services, a consideration for location aiding in the provision of these services, is for the proposed systems to provide such convenience without inadvertently inconveniencing the customer, such as generating large data charges or heavily discharging their mobile device's battery in the process. Under most circumstances, where a mobile device user initiates such services, many resource management considerations such as those previously mentioned could be assigned a lower prioritization, as the user themselves ultimately have some responsibility to choose how they want to prioritize usage. Alternatively, some situations where location requests are initiated remotely may not be treated with the same urgency, if such requests for location aiding cannot provide an appropriate indication of how such services affect a user's convenience or expectations.

However, many critical situations, such as E911 responder support or possibly a user making a 911 call from their mobile device could require some implementations to apply different location aiding session rules to support critically urgent events, possibly overriding user choice, expectation and convenience considerations. As one example, regulatory influence could dictate that services such as medical and or paramedical services support or other such activities and or E911 type emergency services support for associated activities such as could be conducted by governmental emergency and or law enforcement organizations during normal and or extraordinary circumstances where location information could be in a user's or the national interest might necessarily override any number of other location aiding session rules and guidelines which may ordinarily focus completely on a users requirements, expectations and convenience.

As such, some implementations could be directed to monitor for E911 type events, whether mobile originated by a user dialing 911, or originated by third party organizations with sufficient regulatory authority to use all available information and or mobile device resources available to immediately engage location aiding upon the triggering of an E911 type event.

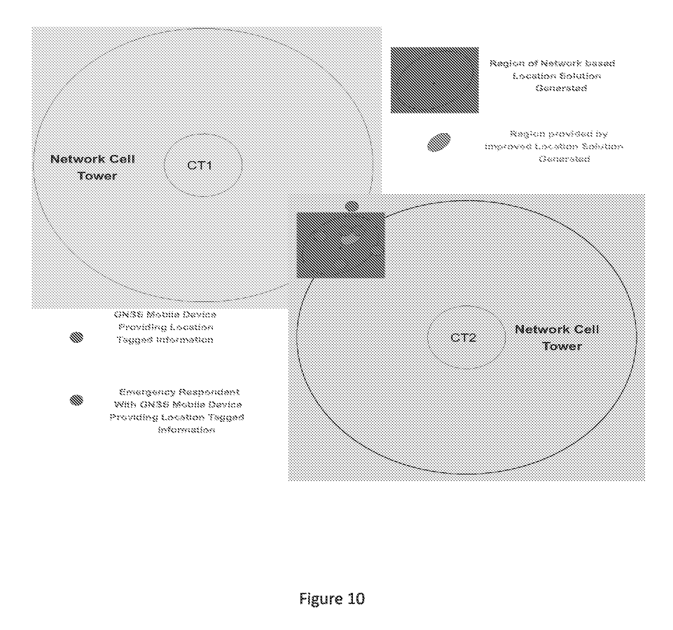

One example of how the location aiding session management processes might address the urgency of such an event could be as described in FIG. 10.

Mobile Network operators have had difficulty meeting regulatory requirements which describe the accuracy with which Network based location services must be able to locate a mobile device during E911 or other such emergency events, for example in the United States, amongst other jurisdictions where such regulatory decrees have been enacted or may be enacted in the future. The mass distribution of GNSS type devices may be required to meet such regulatory requirements, however at this time, and possibly well into the future most mobile devices in use could be non GNSS type mobile devices. An example of how some implementations could be used to improve the chances of locating a mobile device with and or without GNSS, which must be urgently located due to some type of emergency, could be to engage the resources of other locally distributed GNSS enabled mobile devices for the purposes of improving location aiding for the mobile device which needs to be located by emergency respondents who would also likely be using GNSS type devices to support their efforts.

As described above, RF Energy typically permeates most urban and suburban locales where a majority of emergency respondent situations occur. At a basic level, a Network based location service may only be able to locate the mobile device emergency respondents are trying to locate within hundreds of meters, depending on the number of cell towers which can be used to help calculate a solution and or where a GNSS enabled mobile device is otherwise unable to discriminate GNSS signals. Since cell tower densities can vary greatly within a Network's coverage area, there is no way to ensure that enough cell towers with adequate distribution can always be engaged to improve location accuracy in all situations.

As opposed to current art with these types of limitations, one preferred embodiment of the invention would have the Network which was engaged to locate a mobile device more accurately, look at their Home Location Register (HLR) and or the Visitor Location Register (VLR), to determine where one or more available GNSS type mobile devices on the Network may be in the locale. When one or more of these local GNSS type mobile devices contained a client application, such as, but not limited to the GAIM client application, these identified mobile devices could then be utilized to improve the accuracy of the location solution which the Network based location service can calculate by providing near real time location tagged RF information about the locale to improve the validity and accuracy of such calculation. One or more of these mobile devices could be in the possession of emergency respondents, who could be at or near the location which the initial Network based location service calculation indicated, such as a location describing an area of 500 meters in extents, which defines the region the emergency responders would first go to.

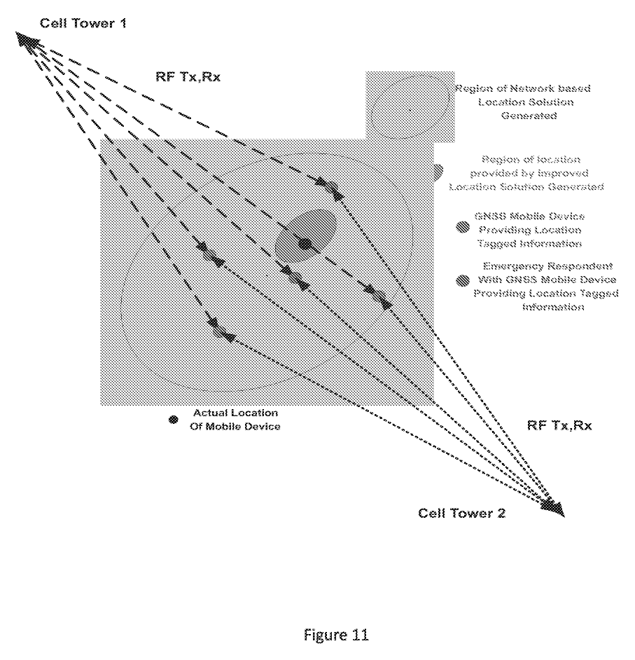

FIG. 11 provides an example where two cell towers available described a possible location of a mobile device, and other GNSS mobile devices within a locale where methods and systems proposed operating on such local GNSS mobile devices could be used to effect location accuracy improvements for the benefit of emergency responders.

Such distribution, as described in FIG. 11, would allow the GNSS mobile device's to provide additional information, which through further triangulation and or trilateration using such information available, could reduce the probable extents of the region defining the location of the mobile device that emergency respondents were attempting to locate by eliminating areas within the region originally proposed by the Network as potential candidate areas within this originally proposed region as possible areas which could form part of the defined region.

### Network Coverage and or Health Characterization/Analysis

### Drive by Testing of Network Coverage and or Network Health

There is an acknowledged need by the mobile and other such industries to understand how well their RF Network coverage deployments provide connectivity for mobile subscribers and or other Ad Hoc users of these types of services. Mobile and or other such industries could include mobile Networks such as GSM, CDMA or other such wide area Network deployments, or Bluetooth and or IEEE 802.11 or other such Local Area Network deployments, or possibly broadly accessible broadcast Networks such as AM, FM or Satellite as could be accessible to the systems and or subsystems of Mobile Devices and or PNDs. Current engineering practices by those skilled in the art of these Networks typically use mobile equipment which could interpret the RF characteristics of the Network locally, which are used to perform a service typically referred to as Drive By testing, amongst other names which could be used, hereinafter referred to as Drive By testing. This is accomplished by utilizing RF equipment which could scan and or transmit on the operating frequencies owned by the Network owner, which could then determine the robustness or lack of robustness of RF signals and or connectivity being generated by and in between Network equipment in the region and the RF equipment being utilized for the Drive By test. The routes driven typically must provide this information with as much distribution within the environment as can be practically and economically achieved.

Additionally, this same test equipment could send signals of varying strength to gauge the level of RF sensitivity and or connectivity between the mobile testing equipment and possibly whether the Network is operating within normal operating guidelines established by Network equipment suppliers and or Network engineers responsible for making such determinations of normal and or possibly acceptable Network operation, or possibly the unacceptability of such operation as could be determined by such testing. This type of testing typically utilizes driven vehicles with installed GNSS type equipment to determine the exact location and or locations of the equipment during these tests, and incorporate specialized systems which actively record RF test information concurrent with the determined locations at the exact time of these RF tests into a database for subsequent post Drive By analysis.

Ultimately, Network engineers who have access to the precise locations of the Network towers and other associated equipment, can then determine the relative distance between individual cell towers and the Drive By equipment, which provides a fairly exact approximation of the distances between Cell Towers and Test equipment at any given time during a test. Understanding these distances allows engineers to compare the characteristic and or theoretical penetration and propagation characteristics of their Network RF frequencies at the power levels of the test equipment and Network facilities at the time of testing to the actual RF signal values recorded during the testing. Without establishing a reasonably precise distance between the two RF sources, the testing would be of little value in the characterization of a Network's RF environment. Using these known distances and locations allow engineers to utilize RF modeling tools which compare the theoretical propagation characteristics of a signal of a known power and frequency over the known distance to the actual data gathered to characterize the quality of service being demonstrated through such testing.

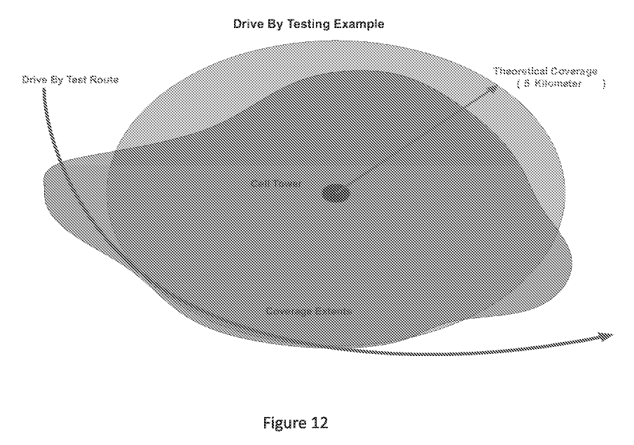

One example of why this is the case would be where established RF propagation and penetration guidelines for the Network frequencies suggest that a cell tower's location and antennae were theoretically optimal, based on the coverage area desired, such as an example of five kilometers in diameter, where the engineers find in practice that when they analyze the Drive By data generated between test equipment that is located five kilometers from this cell tower that acceptable performance has in fact been documented. However, in many cases, the effective coverage distance could be more or less than five kilometers anywhere around the circumference of this theoretical coverage footprint, based on any number of, and or combination of, barriers to the penetration and propagation of the signal and or any number of, and or combination of, other more variable conditions, such as other sources of local RF energy, which could account for differences between the initial theoretical coverage expectations of the Network design engineers and the empirical findings inferred from the Drive By Test data. An example showing how this could inadvertently occur is shown in the FIG. 12.

It can be seen in FIG. 12 that Drive By data collected, based on the route taken would suggest that a 5 Kilometer coverage estimate had tested out positively, whereas there are a number of areas around the tower within the 5 Kilometer estimate which do not. It could be concluded at that juncture by one knowledgeable in the art that the actual performance of a mobile device operating within this same region could also vary widely from any particular position five kilometers away from the aforementioned tower, being some difference of position along the circumference of the theoretical coverage footprint and or based on variations in the prevailing conditions at the time of such operation at that different location. The challenge for both the engineers that design Networks and for those that must necessarily perform such testing to characterize the results of these designs is that it would be economically and or physically impossible to practically test the coverage of this cell site from enough spatially distributed locations within the theoretical coverage, given that Drive By testing could only be performed along navigable roadways, and under a wide enough variety of prevailing times and conditions to improve the certainty of their test results using the current art.

### Analysis of Available Network Operational Information

To overcome some of the limitations of Drive By testing and to further characterize a Network, a strategy could be used to analyze Network data which is typically gathered during the normal operation of a mobile Network, where analysis tools could be used to deduce regions where the Network coverage appears to be either inadequate or improperly deployed or other such factors which could influence the operation of a Network, by reviewing Network management data which is typically transmitted between mobile devices and Network equipment, such as cell towers, during its normal operation. More detailed analysis might also involve using both data sets to provide further clarification of the Network's attributes or health through further interpolation. Both of these methods of determining a Network's coverage, operating characteristics and or health have limitations which are well understood by those knowledgeable in the art.

One significant limitation of Drive By analysis is that it can only characterize a Network's operating characteristics during the period of time that the testing is being performed from the relatively narrow distribution of locations it is gathered from, which means that the data available for subsequent analysis would be less useful for understanding how a Network operated in differing weather conditions, different times of day, variations in background RF energy levels, but probably most importantly, in the much larger percentage of different locations where precise Drive By analysis was not or could not be performed. Drive By analysis can be cost prohibitive, which limits the economic scope of and frequency of these types of tests. Even with these limitations, Drive By testing is routinely performed and used by engineers, as it does provide qualitative data in the form of precise RF measurements taken at precise locations throughout the Network area, which with further analysis provides a statistically sound characterization of the Network in the areas and at the time of such testing.

Using available Network data has some advantages in that it does provide a much larger volume of data which can provide some statistically significant insights into a Network's coverage, health and operation over the broader Network area, rather than being limited to specific Drive By areas. Also, since the Network data is typically recorded 7/24/365, there is an additional ability to have a deeper understanding of how a Network might operate during different times of the day and under differing climatic and seasonal conditions and is useful for discovering whether there has been performance degradation over time. However, since this historical data does not contain a specific RF signal location reference, and there is significantly less ability to specifically characterize the precise RF characteristics of the locale at the time, this type of analysis also has intrinsic limitations.

### Network Health and Coverage

As opposed to the previously described strategies, some proposed implementations record real time RF signal information and or other types of locally available information, such as might be available from a mobile's RF Systems or other similar RF Network signals in combination with the location information that a GNSS or other similarly accurate location awareness system might provide as it became or whenever it became available, or in the case of a PND with an imbedded GSM, CDMA or similar Network connectivity could be gathered on a fairly continuous basis during its normal operation.

Some implementations could provide location tagged Network RF information, such as can be gathered via drive by testing, but economically deliver the statistically significant volumes and geographically distributed data normally only available through the access of Network management statistical data. One example implementation could be to have this information captured and recorded whenever a GNSS or other type of location aware system was active on any mobile device such as a handset or wirelessly enabled PND, or where location information of a certain validity and or quality was available to the mobile device through any number or types of means, that could then be sent to a remote database server or system for subsequent interpretation, interpolation or analysis, storage and possibly archival of said collected information for longer term analysis.

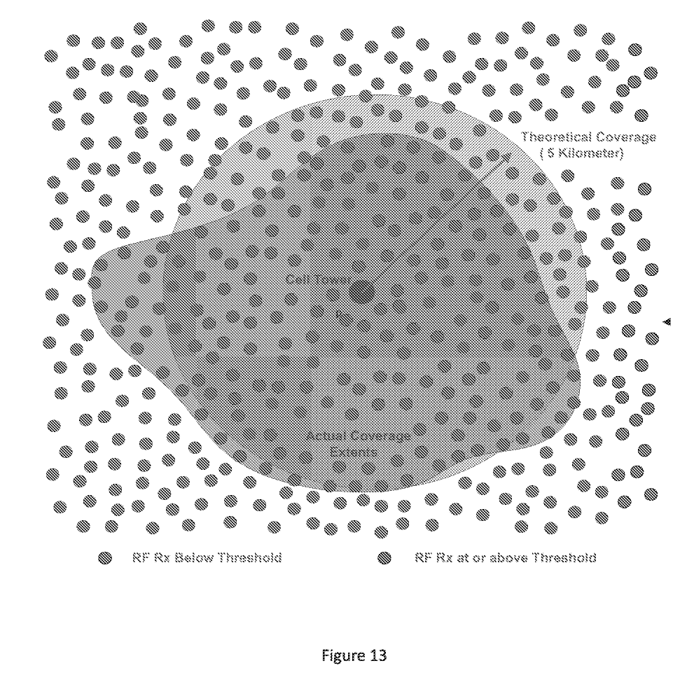

While there would be many ways to beneficially interpret such information, one of many such examples that could be used to characterize the coverage of a Network cell would be to have analysis performed that separated RF Rx values into two groups; those values where received signal levels were at or above acceptable thresholds, and those below acceptable signal levels. Since the location of each sample is accurately known, as is the cell tower location, and the 5 kilometer diameter coverage expectation, all such information can then be overlaid in a single pictorial presentation which would clearly show the actual extents of coverage as defined by signal levels at or above the desired signal level threshold that designers needed, such as in FIG. 13. In this same manner, signal levels could be separated into many levels, offering a more gradient representation to be presented.

Some further implementations could utilize the much higher GNSS activity levels of a PND to record bulk location information actively, while also concurrently recording available Network signal information, which could be stored until it could be most efficiently and economically retrieved using enhanced information and or use data compression that increased the information to data ratio of such payloads so as to make it available more economically. Some implementations could capture and record this information whenever a GNSS or other type of location awareness system was active on any mobile device such as a handset or wirelessly enabled PND, or where location information of a certain validity and or quality was available to the mobile device through any number and or types of means, that could then be sent to another co-located mobile device or wirelessly connected PND for subsequent interpretation, interpolation or analysis.

Another example could be where any location aware mobile device or devices was or were connected to any number or type of external RF Systems or subsystems expressly for the purpose of utilizing the location awareness, processing capability and or memory storage capacity of such devices to perform or have performed a type of RF characterization, such as, but not limited to, a Network coverage and or health analysis on either a passive or active basis, where such connected external systems could characterize one or more RF frequency, individually or collectively, which could effectively emulate or otherwise represent information which could be used alternatively and or in addition to performing a Drive By test or other such testing which those knowledgeable in the art could utilize in lieu of such testing.

Another example could be that this information could be captured and recorded whenever a GNSS or other type of location awareness system was active on a plethora of mobile devices such as on mobile handsets or wirelessly enabled PNDs, or where location information of a certain validity and or quality was available to any number or volume of mobile devices through any number or types of means, that could be gathered over a period of time, where this data being collected became a historical database of information which characterized any number of regions or areas where mobile devices operate, and that all or part of this information or specific analysis which used this information could be placed in the memory of any number of or type of mobile devices or wirelessly connected PNDs for subsequent interpretation, interpolation or analysis which could aid in the performance of a mobile device, such as its location aware systems or subsystems, and or by a PND or wirelessly connected PND which subsequently could perform useful post processing of such information.

Whether this locally recorded information was made available to a server based application or to mobile device based applications via some type of peer to peer protocol or other such type of connectivity, or the information came pre-loaded in memory or was uploaded via internet such interpretable information could be redistributed on some scale which would provide superior characterization of a Network, the probable characteristics of this environment, its coverage and or other operating characteristics, as well as provide very specific characterization of any locale where such mobile devices operated.

An additional benefit of the invention could be that since this information harvesting would not be limited to any specific RF Network, topology or system, such as the art previously described that is typically used to characterize an individual Network and or set of Network frequencies, but rather would organize all available RF information gathered around the specific location information available at the time of capture, which could include, but would not be limited to available RF Systems and subsystems and or other such technologies, that a much broader insight into any given environment that any given mobile device could be operating in, and how differing mobile devices could operate within any given environment, could be more precisely determined. In many jurisdictions, as one example, multiple networks operate, where signals from possibly a dozen or more cell towers could be captured by scanning GSM and or CDMA frequencies, as opposed to just the Cell Towers of a mobile subscribers Network, which could provide significantly better quality information about a mobile device's locale. One example of the benefit of using signal information available from other Networks could be to improve E911 Network Location services performance, such as described in FIG. 13, where the additional capture of RF signals from the Cell Towers of other Networks within a locale could allow the mobile devices in the region to use the systems and methods proposed to improve the accuracy, if such locations were known by the primary Network location service and or known by the local mobile device client applications, and or where prior use had previously characterized the locations of such Cell Towers to an accuracy suitable for these purposes.

Some implementations could use the methods described where such information could be captured with little or no impact on battery capacity or user requirements, for example having this information captured whenever a mobile device is being charged, or possibly only when a mobile device is being charged over night. Examples of additional benefits of this strategy could be that the captured information could be sent during the off peak period of a Network and the likelihood that a large percentage of mobile device subscribers would be located at their primary residences, and as such the information captured would be well distributed across a broad selection of locations throughout a Network's region, possibly improving its use for characterization of a Network's coverage. Another benefit would be that most of the mobile devices being charged would be indoors, providing more meaningful in-building coverage statistics than could be acquired by using the Drive-By method.

### The Benefits of Multi-Frequency RF Location Characterization

Unlike Drive By or Network Data analysis, which typically only characterizes a Network's characteristics over a specific frequency or frequencies, locally gathered information from a Mobile Device, such as available RF systems, provides a unique opportunity to characterize a much broader spectrum of frequencies, which could deliver an improved ability to characterize both the local operating environment that any given mobile device could be operating in, as well as providing a much richer set of data for the purposes of the long term characterization of RF operability and or interoperability within a locale or region, such as for the purposes proposed. For such information to be fully valued however, it may need to be captured simultaneous with the capture of location information of quantifiable accuracy, such as the accuracy of locations used in the Drive By art described or from a GNSS enabled device. This simultaneous capture could allow those knowledgeable in the art of multi-frequency RF analysis to use penetration and propagation modeling tools specific to the individual frequencies of the information harvested to provide improved characterization of an environment due to the fact that the individual RF frequencies' differing but known characteristics, such as but not limited to the effective propagation distances and penetration characteristics through different mediums at different signal power levels between said mobile devices and Network equipment and or other similarly configured mobile devices also known to be situated at known locations, would provide superior characterization of a local environment through the interpolation of such multi-frequency data than could be accomplished through the interpretation of individual RF tests being performed on these same frequencies using separate equipment at separate times in separate locations.

The passive or active capture of multi frequency data from, as an example, more than a million mobile devices within a Network subscriber base, which could be frequently performed economically, such as when a mobile device was being charged at night, would provide a massively large statistical sampling of data that otherwise would not be economically or even practically available using current methodologies, such as prior art described. One example of how subscribers could provide information of this type could be where a mobile operator and or Network operator shipped all or a portion of the phones marketed to subscribers with an application, such as but not limited to the GAIM application. The mobile operator and or Network operator could then cause mobile devices with the application to capture information on a schedule of their choosing, using all or a portion of the shipped devices to capture information which was collected on some schedule to be used for the purposes of characterizing their Network coverage or possibly for reuse by third parties for other purposes.

Also to be considered in this analysis could be the various modulation techniques used within the various frequency ranges. As example, but not limited to such example, that in any number of multijurisdictional areas, regulation caused certain frequencies to be awarded for differing commercial uses, such as licensed domains awarded for specific use and modulation techniques and unlicensed frequency domains where possibly a variety of modulation techniques could be in use, such as where, IEEE 802.11 and Bluetooth share unlicensed frequency domain in certain jurisdictions, and that the capture of such modulation techniques therefore would provide further indication of the locale of a mobile at the time of capture.

Some implementations could use the interpolated frequency information and or analysis of same to better characterize when and or where a mobile device could or should be attempting to initiate connectivity over any of a number of imbedded RF systems and or other similar subsystems or some combination of same either in parallel and or serially, which could offer adequate connectivity for the intended purpose of effecting voice and or data communication or otherwise causing the capture of meaningful or useful information events, or where external Network equipment or applications or other means could or should make similar attempts for connectivity to said device or devices through these imbedded systems or subsystems, and or possibly to improve the experience of a user, and or improve the possibility of such attempt to be successfully completed, and or select and then use the most economic system or subsystem available at the time of the attempt for such connectivity, and or making these same elections and or selections in a manner which reduces the power consumed during such an attempt or otherwise similarly reduces the impact such attempt or attempts could have on a mobile device, PND and or other such devices with imbedded capabilities, whether these elections and or selections were desired and or considered necessary by the user or possibly desired and or considered necessary by the provider of a Network service or were performed automatically through the use of an external and or imbedded algorithm designed for the purposes of effecting connectivity of such types and manners as could be considered or otherwise deemed to be optimal through the operational RF Systems availability at or near the time of such a connectivity attempt.

Such connectivity attempts could include, but would not be limited to, an application which managed voice calls that could make such a call through either a primary Network RF connection such as GSM and or CDMA and or other such mobile Network service, which also had similar capability to complete such a call attempt or via VOIP or some other internet based voice call over Bluetooth and or IEEE 802.11 and or other such RF subsystems with sufficient bandwidth and or data capacity to perform as the connection for such a voice call, which could make an election or selection of a preferred system and or subsystem either due to the availability and or non-availability and or otherwise recognized the possibility of alternative connection means being available before, or possibly during, a voice call that could cause the election or selection of a preferred connectivity system or subsystem. Such election could be to improve the experience of the user and or provide improved economics and or to conform to some type of business rules which could also provide guidelines for how such a voice call and or data transmission and or information capture attempt could therefore need to conform to be completed.

### OTHER EXAMPLES

Another practical way to provide convenience to a user, could be to have some implementations, loaded as software or otherwise contained in the SIM of a mobile device, and or information as defined by this document or both, which would allow a user to benefit from the proposed systems or methods on more than one mobile device by transferring such a SIM from one mobile device to be used in one or more other mobile device's which a user may choose to use. Under such circumstance, as one example, a mobile device user over time may use the proposed systems and methods to partially or fully characterize an environment's mobile operating characteristics, such as IEEE 802.11 and or Bluetooth hotspots where they are able to acquire data transmission services, allowing them to enjoy the convenience of these alternatives as opposed to possibly slower and or more expensive Network data services. By having this type of information available and contained in their SIM, such conveniences can be transferred to a subsequent mobile device, allowing the subsequent mobile device to offer these same conveniences.

With the proliferation of Network enabled and or otherwise wirelessly enabled PNDs, many will require a SIM to be able to connect to a commercial GSM or other type of Mobile Network. For reasons of convenience, and or possibly to reduce costs, many users could use one SIM which they might transfer between their mobile device and their PND, depending on which device they chose to employ at any given time. As described earlier, a PND may provide more rapid characterization of an environment due to the high activity levels of the on board GNSS, due to the shorter time period it might take to acquire sufficient information densities from within a locale or region, and when this same SIM was transferred back to the mobile, could provide these same benefits to the user, but on their mobile device which then employed the SIM being shared between devices. One example of how this could provide value and convenience could be where one or more mobile devices sharing a SIM with a PND, did not have GNSS capability, but other imbedded RF Systems which would allow the use of location tagged RF information gathered and stored in the SIM during PND use, to provide location awareness to the otherwise location unaware mobile devices of a SIM owner.

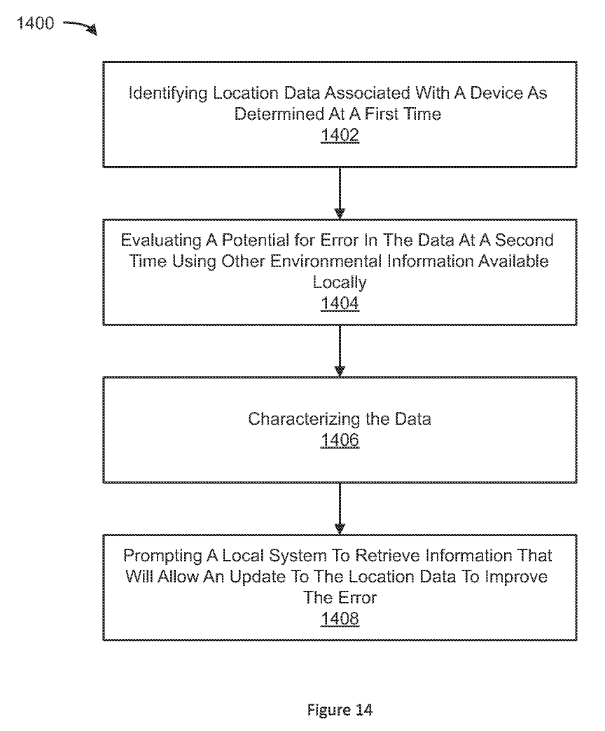

FIG. 14 is a flow diagram of an example process 1400 for updating location data to improve error in the data. In some implementations, the process 1400 includes: identifying location data associated with a device as determined at a first time (1402); evaluating a potential for error in the data at a second time using other environmental information available locally (1404); characterizing the data (1406); and prompting a local system to retrieve information that will allow an update to the location data to improve the error (1408).

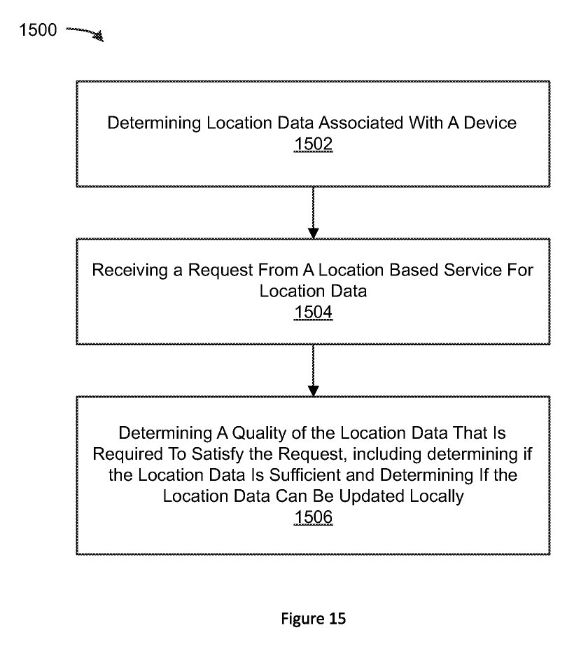

FIG. 15 is a flow diagram of an example process 1500 for determining a quality of location data. In some implementations, the process 1500 includes: determining location data associated with a device (1502); receiving a request from a location based service for location data (1504); and determining a quality of the location data that is required to satisfy the request, including determining if the location data is sufficient and determining if the location data can be updated locally (1506).

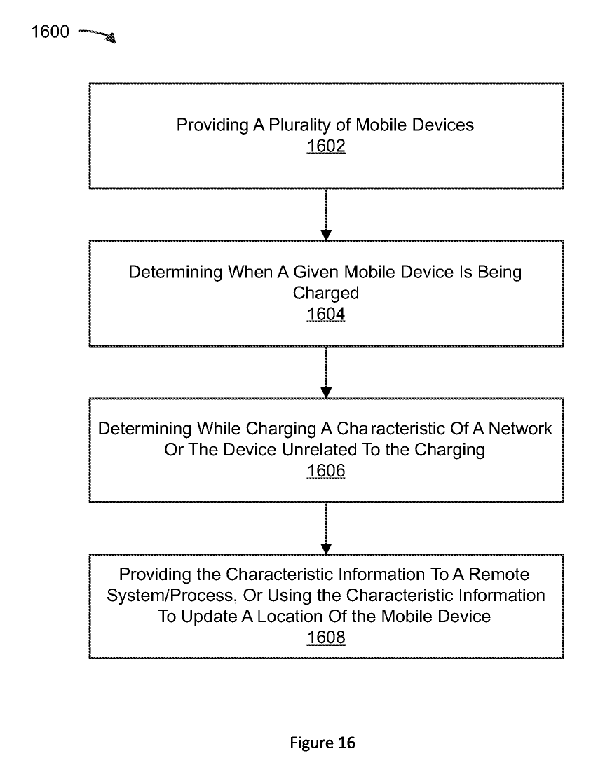

FIG. 16 is a flow diagram of an example process 1600 for determining a characteristic of a network or device while the device is being charged. In some implementations, the process 1600 includes: providing a plurality of mobile devices (1602); determining when a given mobile device is being charged (1604); determining while charging characteristic information of a network or the device unrelated to the charging (1606); and providing the characteristic information to a remote system or process, or using the characteristic information to update a location of the mobile device (1608).

What is claimed is:

1. A device comprising:
a first radio frequency (RF) system that includes a first RF source, the first RF system operable to locate a device;
a second RF system that includes a second RF source, the second RF system operable to communicate with another device;
an application operable to characterize an environment of the device using information gathered when operating the second RF system and provide the assist information to the first RF system to assist in the location of the device.

2. A device comprising:
a radio frequency (RF) system operable to locate the device; and
an application operable to characterize a local environment of the device and provide assist information to the RF system in determining a location of the device.

3. A device comprising:
a radio frequency (RF) system for locating the device including locating the device at a first instance in time;
a location based service requiring a location of the device within a predetermined quality level;
an application operable to characterize an environment of the device and determine if a location of the device as determined by the RF system is sufficiently accurate to satisfy the predetermined quality and if so, provide location data to the location based service, and if not, provide environment information to the RF system for updating a location of the device.

4. A method comprising;
identify location data associated with a device as determined at a first time;
evaluate a potential for error in the data at a second later time using other environmental information available locally;
characterize the error;
prompt a local system to retrieve information that will allow an update to the location data to improve the error.

5. A method comprising:
determining location data associated with a device;
receiving a request from a location based service for location data;
determining a quality of the location data that is required to satisfy the request including
determining if the location data is sufficient; and
determining if the location data can be updated locally.

6. The method of claim 5 further comprising:
if the location data is sufficient using the location data without requesting an update from a remote system.

7. The method of claim 5 further comprising:
if the location data is insufficient
determining an environment of the device;
providing information related to the environment to a remote system to assist in locating the device.

8. The method of claim 7 where determining an environment of the device includes characterizing one or more of the following:
a. radio frequency characteristics of any RF systems associated with the device;
b. proposed or appropriate aiding requirements to support the request;
c. statistical user characteristics and/or preferences, or
d. individual user input.

9. A method comprising:
providing a plurality of mobile devices;
determining when a given device is being charged;
determining while charging a location of the device; and
providing the location information to a remote system.

10. A method comprising:
providing a plurality of mobile devices;
determining when a given device is being charged;
determining while charging characteristic information of a network or the device unrelated to the charging; and
providing the characteristic information to a remote system.

11. A method comprising:
providing a plurality of mobile devices;
determining when a given device is being charged;
determining while charging characteristic information of a network or the device unrelated to the charging; and
using the characteristic information to update a location of the device.

12. The method of claim 11 where using the characteristic information includes updating environment information associated with the device, and providing the environment information along with an assist request to a location service in response to a location based service request.

13. A method comprising:
capturing local parameters and characterizing a local environment of a device; and
providing the captured parameters to a location service along with an assist request.

14. The method of claim 13 where capturing further comprises determining an environment of the device, determining an accuracy associated with the assist request, and determining if more information is required to be gathered locally to update the environment characterization.

15. The method of claim 13 where capturing includes characterizing one or more of the following:
a. radio frequency characteristics of any RF systems associated with the device;
b. proposed or appropriate aiding requirements to support the request;
c. statistical user characteristics and/or preferences, or
d. individual user input.

16. A method comprising:
determining if sufficient local information is available to maintain a predetermined accuracy of location information maintained by a system; and
if not, activate one or more local systems to gather new information and using the new information to update the location information.

17. A method for locating a device comprising:
determining location information associated with a proximate device:
providing the location information to the device; and
using the provided location information for updating a location of the device locally.

18. A method for locating a first device comprising:
at a device proximate to the first device, determining a location of the proximate device;
providing the location of the proximate device to the first device; and
using the location of the proximate device to determine a location of the first device including providing the location of the proximate device to a remote system along with an assist request.

19. A method comprising:
providing a first device that includes a removable memory storage element;
determining a location of the first device and storing the location on the removable memory storage element;
removing and placing the removable storage element in a second device; and
using the location information stored in the removable storage element to assist in determining a location of the second device.

20. The method of claim 19 where using the location information includes using the location information to determine an environment of the second device.

21. The method of claim 19 where using the location information includes providing the location information to a remote system along with an assist request.

22. A method comprising:
providing a plurality of mobile devices;
determining when a given device is being charged;
determining while charging a characteristic of a network that the mobile device is coupled to unrelated to the charging; and
providing the characteristic to a remote process for further evaluation.

23. The method of claim 22 where the characteristic is network coverage.

24. The method of claim 22 further comprising providing the characteristic along with location information associated with a location of the mobile device.

25. A method comprising:
providing a plurality of mobile devices;
determining a non-peak time associated with operation of the mobile device;
determining during the non-peak time a characteristic of a network to which the mobile device is coupled; and
providing the characteristic to a remote process for further evaluation.

26. The method of claim 25 where the characteristic is network coverage.

27. The method of claim 25 further comprising providing the characteristic along with location information associated with a location of the mobile device.
